(19) United States
(12) Patent Application Publication
(10) Pub. No.: US 2026/0208478 A1
(43) Pub. Date: Jul. 23, 2026

(54) INTERMEDIATE TRANSFER MEMBER WITH PAPER-BASED LAYER

(71) Applicant: LANDA CORPORATION LTD., Rehovot (IL)

(72) Inventors: Benzion LANDA, Nes Ziona (IL); Ifaa TEREM KOLODKIN, Nes Ziona (IL); Tatiana KURTSER, Petach Tikva (IL); Helena CHECHIK, Rehovot (IL); Sergei SHMAL, Rehovot (IL); Idan GOLDANSKY, Gedera (IL); Itshak ASHKANAZI, Rehovot (IL)

(21) Appl. No.: 19/143,661

(22) PCT Filed: Jan. 2, 2024
(86) PCT No.: PCT/IB2024/050027

§ 371 Date: Jun. 26, 2025

Related U.S. Application Data
(60) Provisional application No. 63/436,690, filed on Jan. 2, 2023.

(51) Int. Cl. B41J 2/005; B32B 5/02; B32B 7/06; B32B 27/10; B32B 27/36; B32B 29/02; B32B 29/06; B41M 5/025

(52) U.S. Cl. CPC B41J 2/0057; B32B 5/024; B32B 7/06; B32B 27/10; B32B 27/36; B32B 29/02; B32B 29/06; B41M 5/0256; B32B 2250/03; B32B 2255/10; B32B 2255/12; B32B 2255/205; B32B 2255/26; B32B 2262/101; B32B 2307/202; B32B 2307/212; B32B 2307/54; B32B 2307/5825; B32B 2413/00

(57) ABSTRACT

An intermediate transfer member (ITM) for use in a printing system includes: (a) a release layer having an upper surface for ink-reception; and (b) a paper-based layer disposed beneath the release layer. In some embodiments, the ITM may further include a glass-fabric layer disposed beneath the paper-based layer. Alternatively, or additionally, the paper-based layer is impregnated with an epoxy (e.g. epoxy resin). A method of printing using a printing system, includes (a) providing any ITM described herein; (b) mounting 2024/147085 the ITM on rollers of the printing system so that the ITM passes through stations of the printing system; (c) forming an endless ITM-loop; (d) forming ink images by ink-droplet deposition upon a surface of the ITM; (e) transporting the ink images on the ITM to an impression station of the printing system; and (f) transferring the ink images to a substrate at an impression station of the printing system. WO

### CROSS-REFERENCE TO RELATED APPLICATIONS

This patent application claims the benefit of U.S. Provisional Patent Application No. 63/436,690, filed on Jan. 2, 2023, which is incorporated herein by reference in its entirety.

### FIELD OF THE INVENTION

The present invention relates to intermediate transfer members (ITM's) for digital printing systems. In particular, the present invention relates to ITMs including a paper layer or a paper-based layer.

### BACKGROUND

Various printing devices have previously been proposed that use an indirect inkjet printing process, this being a process in which an inkjet print head is used to print an image onto the surface of an intermediate transfer member, which is then used to transfer the image onto a substrate. The intermediate transfer member (ITM) may be a flexible belt guided over rollers

PCT/IB 2013/051743, filed on Mar. 5, 2013 and incorporated herein by reference in its entirety, discloses intermediate transfer members having a release layer useful in the art of printing.

PCT/IB 2013/051719, filed on filed on Mar. 5, 2013 and incorporated herein by reference in its entirety, discloses a flexible belt for use in a printing system. The belt comprises an endless strip which, in use, travels along a continuous path. Formations are provided along the sides of the strip which are capable of engaging with lateral tracks to place the belt under lateral tension, the lateral tracks further serving to constrain the belt to follow the continuous path.

PCT/IB 2017/053167 filed on May 30, 2017 and incorporated herein by reference in its entirety, discloses an intermediate transfer member (ITM) for use with a printing system, the ITM having (a) a support layer; and (b) a release layer having an ink reception surface and a second surface opposing the ink reception surface, the second surface attached to the support layer, the release layer formed of an addition-cured, hydrophobic silicone material, wherein the release surface of the release layer has relatively hydrophilic properties with respect to the addition-cured, hydrophobic silicone material.

PCT/IB 2020/060552 filed on Nov. 10, 2020 and incorporated herein by reference in its entirety, discloses a flexible intermediate transfer member (ITM), including a stack of: (a) a first layer, located at an outer surface of the ITM, configured to receive ink droplets to form an ink image thereon, and to transfer the ink image to a target substrate and (b) a second layer including a matrix holding particles configured to receive optical radiation passing through the first layer and to heat the ITM by absorbing the optical radiation. PCT/IB2020/060552 further teaches a printing system comprising (i) the aforementioned ITM, (ii) an illumination assembly, configured to dry the ink droplets by directing the optical radiation to impinge on the particles and (iii) a temperature control assembly configured to control a temperature of the ITM by directing a gas to the ITM.

### SUMMARY

Embodiments of the present invention relate to multi-layer flexible ITM where at least one of the layers of the ITM (e.g. an internal layer of the ITM) is a paper-based. Typically, the ITM has the form factor of an elongated strip where ends thereof are connected (or connectable) to each to convert the strip into a closed loop or belt. The elongated strip (or loop or belt) define two directions—(i) a “”longitudinal“ or ”print direction“ corresponding to the elongate axis of the strip or a circumferential direction of the loop of belt and (ii) the ”“'lateral ”or “cross-print direction” which is perpendicular to the “print direction.”

An intermediate transfer member (ITM) for use in a printing system is described herein. According to some embodiments, the ITM comprises: a. a silicone-based release layer having an upper surface for ink-reception, said upper-surface for ink-reception adapted to satisfy at least one of a first structural property and a second structural property, the first and second structural properties being defined below; b. a paper-based layer which is impregnated with and/or coated with epoxy, said paper-based layer being disposed beneath the release layer including at least 50% or at least 60% or at least 80% or at least 90% paper fiber, the paper-based layer configured to contribute to ITM stiffness such that a ratio between (i) a spring constant in the longitudinal direction of the paper-based layer; and a (ii) a spring constant in the longitudinal direction of the ITM is at least 0.5 or at least 0.6 or at least 0.7 or at least 0.8 c. a grip-layer disposed beneath the paper-based layer, wherein: A. the paper-based layer has a black upper surface and/or the ITM includes comprising an additional electromagnetic-energy-absorbing layer above the paper layer and below the release layer, said energy-absorbing layer comprising black material; B. according to the first structural property, a receding contact angle of a droplet of distilled water on said upper surface of said silicone-based release layer is at most 60°; C. according to the second structural property, for a droplet of distilled water deposited on said upper surface of said silicone-based release layer, a 10 second dynamic contact angle (DCA) is at most 108°.

According to some embodiments, the paper-based layer is impregnated with the epoxy (e.g. epoxy resin mixed with hardener and/or otherwise hardened and/or cured).

Alternatively or additionally, the paper-based layer is coated with the epoxy (e.g. epoxy resin mixed with hardener and/or otherwise hardened and/or cured).

According to some embodiments, a ratio between (i) a spring constant in the longitudinal direction of the paper-based layer; and a (ii) a spring constant in the longitudinal direction of the ITM is at least 0.6 or at least 0.7 or at least 0.8.

According to some embodiments, a ratio between (i) a longitudinal-direction tensile strength in the longitudinal direction of the paper-based layer; and a (ii) a longitudinal-direction tensile strength in the longitudinal direction of the ITM is at least 0.5 or at least 0.6 or at least 0.7.

According to some embodiments, a ratio between (i) a longitudinal-direction tear-resistance in the longitudinal direction of the paper-based layer; and a (ii) a tear-resistance in the longitudinal direction of the ITM is at least 0.5 or at least 0.6 or at least 0.7.

According to some embodiments, a presence of the epoxy in or on the paper-based layer contributes at least 5% or at least 10% or at least 15% or at least 20% or at least 30% or at least 40% or at least 50% to the tensile strength of the ITM in the longitudinal direction.

According to some embodiments, a presence of the epoxy in or on the paper-based layer contributes at least 5% or at least 10% or at least 15% or at least 20% or at least 30% or at least 40% or at least 50% the tear resistance of the ITM in the longitudinal direction.

According to some embodiments, the grip-layer is electrically conductive.

An intermediate transfer member (ITM) for use in a printing system is described herein. According to some embodiments, the ITM comprises: a. a release layer having an upper surface for ink-reception; and b. a paper-based layer disposed beneath the release layer and configured to contribute to ITM stiffness such that a ratio between (i) a spring constant in the longitudinal direction of the paper-based layer; and a (ii) a spring constant in the longitudinal direction of the ITM is at least 0.6, said paper-based layer including at least 50% or at least 60% or at least 80% or at least 90% paper fiber; c. a fabric layer disposed beneath the paper-based layer and configured to contribute to ITM tear resistance such that a ratio between a tear-resistance of the fabric layer in the longitudinal direction and a tear resistance of the ITM in the longitudinal direction is at least 0.6, wherein: i. an average surface roughness of an upper surface of the fabric layer in the ITM is at least 0.5 μm; and ii. an average surface roughness of an upper surface of the paper-based layer is at most 0.2 μm (or at most 0.1 μm or at most 0.05 μm).

The fabric of the fabric layer may be woven or unwoven.

An intermediate transfer member (ITM) for use in a printing system is described herein. According to some embodiments, the ITM comprises: a. a release layer having an upper surface for ink-reception; and b. a paper-based layer disposed beneath the release layer and configured to contribute to ITM stiffness such that a ratio between (i) a spring constant in the longitudinal direction of the paper-based layer; and a (ii) a spring constant in the longitudinal direction of the ITM is at least 0.6, said paper-based layer including at least 50% or at least 60% or at least 80% or at least 90% paper fiber; c. a fabric layer disposed beneath the paper-based layer and configured to contribute to ITM tensile strength such that a ratio between a tensile strength of the fabric layer in the longitudinal direction and a tensile strength of the ITM in the longitudinal direction is at least 0.6, wherein: i. an average surface roughness of an upper surface of the fabric layer in the ITM is at least 0.5 μm; and ii. an average surface roughness of an upper surface of the paper-based layer is at most 0.2 μm.

The fabric of the fabric layer may be woven or unwoven.

According to some embodiments, the fabric layer is a glass-fabric layer (e.g. fiberglass).

According to some embodiments, a ratio between a tear-resistance of the fabric layer in the longitudinal direction and a tear resistance of the ITM in the longitudinal direction is at least 0.8.

According to some embodiments, a ratio between a tensile strength of the fabric layer in the longitudinal direction and a tensile strength of the ITM in the longitudinal direction is at least 0.8.

According to some embodiments, a ratio between (i) a spring constant in the longitudinal direction of the paper-based layer; and a (ii) a spring constant in the longitudinal direction of the ITM is at least 0.8.

According to some embodiments, a ratio between a surface roughness of the ITM upper surface and a surface roughness of an upper surface of the fabric layer is at most 0.1.

According to some embodiments, a surface roughness of an upper surface of the ITM is at at most 0.5 μm or at most 0.25 μm or at most 0.15 μm or at most 0.1 μm after the upper surface of ITM is subjected to at least 1000 2+-second heating(120+° C.)/4+-second cooling (90−° C.) events.

According to some embodiments, the ITM is characterized by an absence of any interior layer of the ITM whose direction-maximized CLTE value is at least 10*10⁻⁶ meter/(meter ° C.) or at least 15*10⁻⁶ meter/(meter at least 20*10⁻⁶ meter/(meter ° C.).

According to some embodiments, the ITM lacks an interior plastic layer (e.g. no plastic sheet as an interior layer).

According to some embodiments, the ITM lacks an interior plastic layer (e.g. no plastic sheet as an interior layer).

According to some embodiments, the ITM is formed by a flat elongate strip of which the ends are secured to one another at a seam to form a continuous loop.

According to some embodiments, the electromagnetic-energy-absorbing layer above the paper layer and below the release layer is a layer of carbon-black-impregnated silicone.

An intermediate transfer member (ITM) for use in a printing system is described herein. According to some embodiments, the ITM comprises: a. a silicone-based release layer having an upper surface for ink-reception, said upper-surface for ink-reception adapted to satisfy at least one of a first structural property and a second structural property, the first and second structural properties being defined below; b.
a paper-based layer which is impregnated with and/or coated with silicone, said paper-based layer being disposed beneath the release layer including at least 50% or at least 60% or at least 80% or at least 90% paper fiber, the paper-based layer configured to contribute to ITM stiffness such that a ratio between (i) a spring constant in the longitudinal direction of the paper-based layer; and a (ii) a spring constant in the longitudinal direction of the ITM is at least 0.5 or at least 0.6 or at least 0.7 or at least 0.8;
c. a grip-layer disposed beneath the paper-based layer, wherein: A. the paper-based layer has a black upper surface and/or the ITM includes comprising an additional electromagnetic-energy-absorbing layer above the paper layer and below the release layer, said energy-absorbing layer comprising black material; B. according to the first structural property, a receding contact angle of a droplet of distilled water on said upper surface of said silicone-based release layer is at most 60°; C. according to the second structural property, for a droplet of distilled water deposited on said upper surface of said silicone-based release layer, a 10 second dynamic contact angle (DCA) is at most 108°.

A method of manufacturing the ITM of any preceding claim, the method comprising: a. providing a release-layer-including-structure and a paper-layer-including structure wherein: i. the release-layer-including structure comprises: A. a sheet of polyethylene terephthalate (PET); and B. the release layer of the ITM of any preceding claim disposed on the PET sheet; ii. the paper-layer-including structure includes the paper-based layer of any preceding claim and optionally an additional optional layer (e.g. grip layer and/or a fabric layer); b. laminating the paper-layer-including structure to the release-layer-including structure by applying an adhesive therebetween, wherein the method is performed so that an adhesion layer of the adhesive is disposed between the release layer of the ITM of any preceding claim and the paper-layer of the ITM of any preceding claim.

According to some embodiments, before the laminating of step (b), the paper-based layer of the release-layer-including structure is coated with and/or impregnated with at least one of epoxy (e.g. epoxy resin optionally mixed with an adhesive) and silicone—e.g. the epoxy may be cured before step (b)

According to some embodiments, the sheet of polyethylene terephthalate (PET) of the release-layer-including structure is coated with a fumed metal.

A printing system comprises: a. any ITM disclosed herein, the ITM mounted the ITM on rollers of the printing system; b. an image-forming station wherein ink images are formed by ink-droplet deposition of an aqueous ink upon a surface of the ITM moving through an image-forming station of the printing system; and c. an impression-station where the ink images are transferred from the ITM to substrate.

A method of printing using a printing system comprises: a. providing any ITM disclosed herein; b. mounting the ITM on rollers of the printing system so that the ITM passes through multiple stations of the printing system; c. forming an endless ITM-loop by joining two ends of the ITM to each other; d. forming ink images by ink-droplet deposition upon a surface of the ITM moving through an image-forming station of the printing system; e. transporting the ink images on the ITM to an impression station of the printing system; and f. transferring the ink images to a substrate at an impression station of the printing system.

A method of printing comprises: a. providing any ITM disclosed herein; b. mounting the ITM on rollers of a printing system so that the ITM passes through multiple stations of the printing system; c. forming an endless ITM-loop by joining two ends of the ITM to each other; and d. rotating the ITM-loop through the multiple stations so that respective portions of the ITM successively pass (i) an image-forming station where ink images are formed by deposition of droplets of an aqueous ink upon an ITM-portion-surface and (ii) an impression station where the ink images are transferred from the ITM to a substrate.

According to embodiments of the invention, an intermediate transfer member (ITM) for use in a printing system comprises: (a) a release layer having an upper surface for ink-reception; and (b) a paper-based layer disposed beneath the release layer.

In some embodiments, the ITM can additionally comprise a glass-fabric layer disposed beneath the paper-based layer.

In some embodiments, the release layer can be silicone-based. In some embodiments, the release layer can be hydrophobic.

In some embodiments, a ratio between a longitudinal-direction tear resistance of the glass fabric layer and longitudinal-direction a tear resistance of the ITM can be at least 0.8. In some embodiments, a ratio between a longitudinal-direction spring constant of the paper-based layer and a longitudinal-direction spring constant of the ITM can be at least 0.3.

In some embodiments, an average surface roughness of an upper surface of the fabric layer in the ITM can be at least 0.25 μm, or at least 0.5 μm, or at least 1 μm. In some embodiments, an average surface roughness of a lower surface of the paper-based layer in the ITM can be at least 0.25 μm, or at least 0.5 μm, or at least 1 μm.

Alternatively or additionally, an average surface roughness of an upper surface of the paper-based layer in the ITM is be at most 0.2 μm, or at most 0.15 μm, or at most 0.1 μm. In some embodiments, an average surface roughness of an upper surface of the release layer can be at most 1 μm, or at most 0.2 μm, or at most 0.15 μm, or at most 0.1 μm.

In some embodiments, the paper-based layer can be thicker than the (e.g. glass) fabric layer.

In some embodiments, a thickness of the ITM can be at least 100 μm or at least 200 μm, or at least 250 μm, or at least 300 μm. In some embodiments, a thickness of the ITM can be at most 600 μm, or at most 500 μm, or at most 400 μm. In some embodiments, a thickness of the paper-based layer can be at least 25 μm, or at least 50 μm. In some embodiments, a thickness of the paper-based layer can be at most 150 μm, or at most 125 μm, or at most 100 μm, or at most 75 μm. In some embodiments, a ratio between a thickness of the paper-based layer and a thickness of the ITM can be at least 0.1, or at least 0.125, or at least 0.15, or at least 0.175, or at least 0.2, or at least 0.225, or at least 0.25, or at least 0.275, or at least 0.3, or at least 0.35, or at least 0.4, or at least 0.45, or at least 0.5.

In some embodiments, the ITM can be in the form of an elongated belt defining an elongate longitudinal direction and a traverse direction perpendicular thereto, and a ratio between (i) a longitudinal-direction tensile-strength of the paper-based layer, and (ii) a longitudinal-direction tensile-strength of the ITM, can be at least 0.1, or at least 0.2, or at least 0.3, or at least 0.4, or at least 0.5, or at least 0.6, or at least 0.7, or at least 0.8, or at least 0.85, or at least 0.9.

In some embodiments, the upper surface of the release layer can coincide with an upper surface of the ITM.

In some embodiments, a thickness of the release layer can be least 50 μm, or at least 100 μm. In some embodiments, a thickness of the release layer can be at most 250 μm, or at most 200 μm, or at most 150 μm. In some embodiments, a ratio between a thickness of the release layer and a thickness of the ITM can be at most 0.6, or at most 0.5, or at most 0.4, or at most 0.3. In some embodiments, a ratio between a thickness of the release layer and a thickness of the ITM can be at least 0.2, or at least 0.3.

In some embodiments, a ratio between a thickness of the release layer and a thickness of the paper-based layer can be at least 0.5. In some embodiments, a ratio between a thickness of the release layer and a thickness of the paper-based layer can be at most 6, or at most 5, or at most 4, or at most 3, or at most 2.5, or at most 2, or at most 1.75.

In some embodiments, the release layer can have a lower surface facing towards the paper-based layer, and/or a ratio between (i) a vertical displacement between the lower surface of the release layer and the paper-based layer, and (ii) a thickness of the ITM, can be at most 0.2, or at most 0.15, or at most 0.1, or at most 0.05.

In some embodiments, a thickness of the glass-fabric layer can be at most 100 μm, or at most 75 μm, or at most 50 μm. In some embodiments, a ratio between a thickness of the glass-fabric layer and a thickness of the paper-based layer can be at most 0.5. In some embodiments, a ratio between a thickness of the glass-fabric layer and a thickness of the ITM can be at most 0.2, or at most 0.15, or at most 0.1.

In some embodiments, it can be that the ratio between the tear resistance of the glass fabric layer and the tear resistance of the ITM is at least 0.8, and the ratio between the spring constant of the paper-based layer and the spring constant of the ITM is at least 0.3, at 100° C. In some embodiments, the ratio between the tear resistance of the glass fabric layer and the tear resistance of the ITM can be at least 0.9.

In some embodiments, the ITM can have a total length of at least 7 m, or at least 8 m, or at least 9 m, or at least 10 m.

In some embodiments, wherein the paper-based layer can include a coated paper. In some such embodiments, the coated paper can include an epoxy resin.

A method is disclosed, according to embodiments, for printing using a printing system. The method comprises: (a) providing an ITM according to any one of the embodiments disclosed hereinabove; (b) mounting the ITM on rollers of the printing system so that the ITM passes through multiple stations of the printing system; (c) forming an endless ITM-loop by joining two ends of the ITM to each other; (d) forming ink images by ink-droplet deposition upon a surface of the ITM moving through an image-forming station of the printing system; (e) transporting the ink images on the ITM to an impression station of the printing system; and (f) transferring the ink images to a substrate at an impression station of the printing system.

In some embodiments, the ink-droplets can comprise an aqueous ink.

In some embodiments, during the forming and transferring, respective portions of the ITM passing through the image-forming station and the impression station can be at temperatures of at least 100° C. In some embodiments, at least a lengthwise majority of the ITM can be at a temperature of at least 140° C. during the forming, transporting and transferring. In some embodiments, at least a portion of the ITM can be at a temperature of at least 200° C. during at least one of the forming, transporting and transferring.

In some embodiments, the transporting of the ink images from the image-forming station to the impression station can be over a distance of at least 3 m, or at least 4 m, or at least 5 m, or at least 6 m.

A method of printing is disclosed, according to embodiments. The method comprises: (a) providing an intermediate transfer (ITM) comprising a release layer having an upper surface for ink-reception, and a paper-based layer disposed beneath the release layer; (b) mounting the ITM on rollers of a printing system so that the ITM passes through multiple stations of the printing system; (c) forming an endless ITM-loop by joining two ends of the ITM to each other; and (d) rotating the ITM-loop through the multiple stations so that respective portions of the ITM successively pass (i) an image-forming station where ink images are formed by deposition of droplets of an aqueous ink upon an ITM-portion-surface and (ii) an impression station where the ink images are transferred from the ITM to a substrate.

In some embodiments, the ITM can additionally comprise a glass-fabric layer disposed beneath the paper-based layer.

In some embodiments, the release layer can be silicone-based. In some embodiments, the release layer can be hydrophobic.

In some embodiments, a ratio between a tear resistance of the glass fabric layer and a tear resistance of the ITM can be at least 0.8. In some embodiments, a ratio between a spring constant of the paper-based layer and a spring constant of the ITM can be at least 0.3.

In some embodiments, during the forming and transferring, respective portions of the ITM passing through the image-forming station and the impression station can be at temperatures of at least 100° C. In some embodiments, at least a lengthwise majority of the ITM can be at a temperature of at least 140° C. during the rotating. In some embodiments, at least a portion of the ITM can be at a temperature of at least 200° C. during at least one of the rotating.

In some embodiments, the transporting of the ink images from the image-forming station to the impression station can be over a distance of at least 3 m, or at least 4 m, or at least 5 m, or at least 6 m.

In some embodiments, an average surface roughness of an upper surface of the glass fabric layer in the ITM can be at most 10 μm, or at most 5 μm, or at most 3 μm, or at most 2 μm, or at most 1 μm. In some embodiments, an average surface roughness of a lower surface of the paper-based layer in the ITM can be at most 10 μm, or at most 5 μm, or at most 3 μm, or at most 2 μm, or at most 1 μm. In some embodiments, an average surface roughness of an upper surface of the paper-based layer in the ITM can be at most 1 μm, or at most 0.5 μm, or at most 0.25 μm, or at most 0.2 μm. In some embodiments, an average surface roughness of an upper surface of the release layer can be at most 1 μm, or at most 0.5 μm, or at most 0.25 μm, or at most 0.2 μm.

In some embodiments, the paper-based layer can be thicker than the glass fabric layer.

In some embodiments, a thickness of the ITM can be at least 100 μm or at least 200 μm, or at least 250 μm, or at least 300 μm.

In some embodiments, a thickness of the ITM can be at most 600 μm, or at most 500 μm, or at most 400 μm. In some embodiments, a thickness of the paper-based layer can be at least 25 μm, or at least 50 μm. In some embodiments, a thickness of the paper-based layer can be at most 150 μm, or at most 125 μm, or at most 100 μm, or at most 75 μm. In some embodiments, a ratio between a thickness of the paper-based layer and a thickness of the ITM can be at least 0.1, or at least 0.125, or at least 0.15, or at least 0.175, or at least 0.2, or at least 0.225, or at least 0.25, or at least 0.275, or at least 0.3, or at least 0.35, or at least 0.4, or at least 0.45, or at least 0.5.

In some embodiments, it can be that the ITM is in the form of an elongated belt defining an elongate longitudinal direction and a traverse direction perpendicular thereto, and a ratio between (i) a longitudinal-direction tensile-strength of the paper-based layer, and (ii) a longitudinal-direction tensile-strength of the ITM, is at least 0.1, or at least 0.2, or at least 0.3, or at least 0.4, or at least 0.5, or at least 0.6, or at least 0.7, or at least 0.8, or at least 0.85, or at least 0.9.

The tensile strength of the paper layer can be measured using an industry-standard test such as the TAPPI T404 test. TAPPI is the Technical Association of the Pulp and Paper Industry.

In some embodiments, the upper surface of the release layer can coincide with an upper surface of the ITM.

In some embodiments, a thickness of the release layer can be least 50 μm, or at least 100 μm. In some embodiments, a thickness of the release layer can be at most 250 μm, or at most 200 μm, or at most 150 μm. In some embodiments, a ratio between a thickness of the release layer and a thickness of the ITM can be at most 0.6, or at most 0.5, or at most 0.4, or at most 0.3. In some embodiments, a ratio between a thickness of the release layer and a thickness of the ITM can be at least 0.2, or at least 0.3. In some embodiments, a ratio between a thickness of the release layer and a thickness of the paper-based layer cam be at least 0.5. In some embodiments, a ratio between a thickness of the release layer and a thickness of the paper-based layer can be at most 6, or at most 5, or at most 4, or at most 3, or at most 2.5, or at most 2, or at most 1.75.

In some embodiments, a ratio between (i) a vertical displacement between the lower surface of the release layer and the paper-based layer, and (ii) a thickness of the ITM, can be at most 0.2, or at most 0.15, or at most 0.1, or at most 0.05.

In some embodiments, a thickness of the glass-fabric layer can be at most 100 μm, or at most 75 μm, or at most 50 μm. In some embodiments, a ratio between a thickness of the glass-fabric layer and a thickness of the paper-based layer can be at most 0.5. In some embodiments, a ratio between a thickness of the glass-fabric layer and a thickness of the ITM can be at most 0.2, or at most 0.15, or at most 0.1.

In some embodiments, the ITM can have a total length of at least 7 m, or at least 8 m, or at least 9 m, or at least 10 m.

### DETAILED DESCRIPTION OF THE ILLUSTRATED EMBODIMENTS

The present invention relates to intermediate transfer members (ITM) for digital printing systems—e.g. having the form of a belt mountable over a plurality of rollers, or having the form of an elongated strip which is convertible into a belt by attachment of opposite ends of the strips to each other. Both of these form factors define ‘lateral’ and ‘longitudinal’directions.

In particular, the present invention relates to ITMs including a paper-based layer—for example, the paper-based layer is interior layer of the blanket. This ITM may be employed in a printing process whereby (i) liquid material including ink is deposited onto an upper surface of the ITM and (ii) subsequently the ITM is heated (e.g. significantly so) to evaporate away solvent. This may be formed multiple times (e.g. at least 100× or at least 500× or at least 1000× or at least 5,000× or at least 10,000× or at least 50,000× or a least 100,000×) where the upper surface of the ITM is heated and cooled repeatedly.

Unless indicated otherwise, physical properties whose value depends on temperature refers to the value of that property at 100° C. By way of example, a tensile strength refers to a tensile strength at 100° C.

For the present disclosure, the terms “ITM” and blanket are used interchangeably.

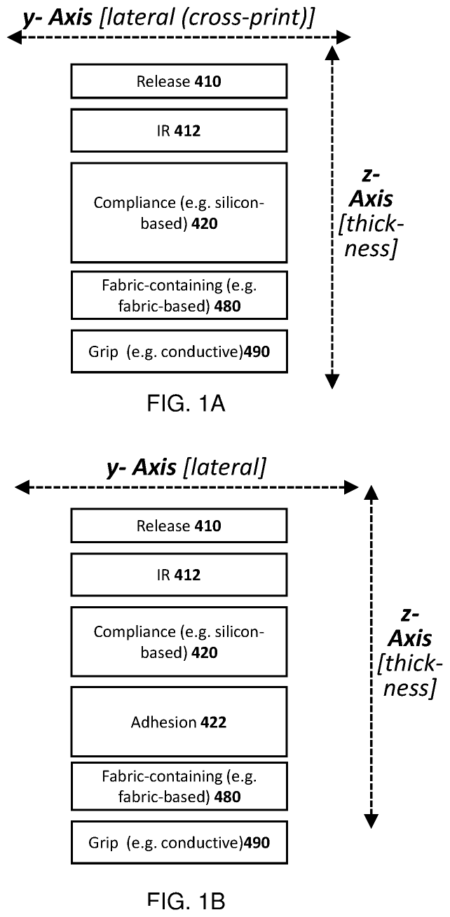

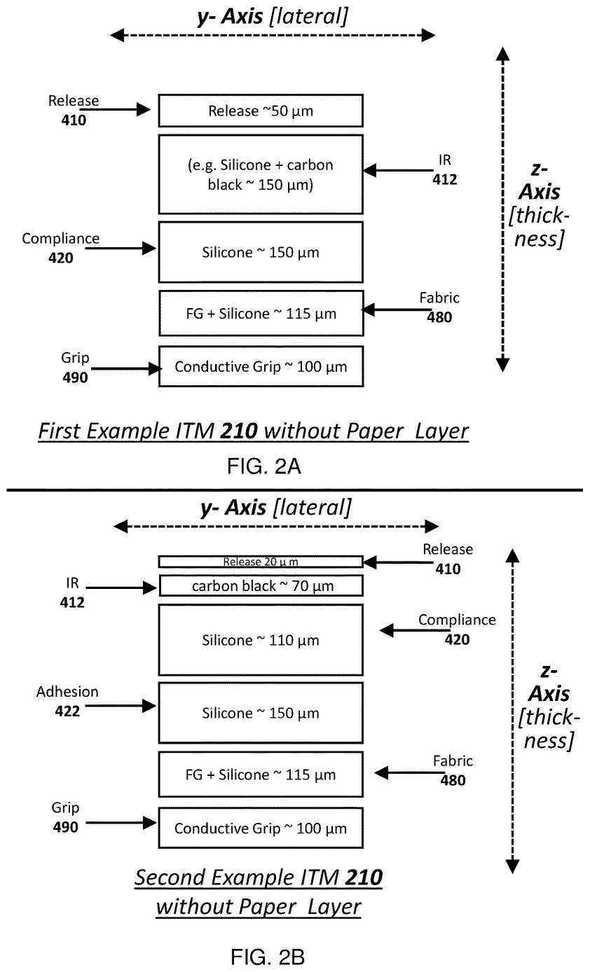

### FIGS. 1A-1B and 2A-2C (Blankets Lacking a Paper-Based Layer)

FIGS. 1A-1B and 2A-2C relate to intermediate transfer members (ITM) lacking a paper layer. Nevertheless, certain components and/or layer(s) of ITM are also provided in ITMs including a paper based layer(s), and the description provided in the present section (e.g. respect to 410 and/or 412 and/or 420 and/or 490) may be relevant for ITMs 210 including a paper-based layer, when these paper-including ITMs also include layer(s) 410 and/or 412 and/or 420 and/or 490.

One example of an ITM lacking any paper-based layer is disclosed in PCT/IB 2020/060552 filed on Nov. 10, 2020 incorporated by reference.

The ITM of FIG. 1sA comprises two “exterior layers”—(i) release layer 410 and (ii) conductive grip layer 490, which are both discussed below.

### Internal Layers—The ITM of FIGS. 1A-1B Comprises Three “Interior Layers” (and an Optional Fourth Layer)

A. a fabric-containing layer 480 (or skeleton layer) for providing mechanical strength, albeit at a possible ‘cost’ such that an upper surface of fabric-containing layer 480 may have a surface roughness that exceeds what is desired for that of the upper surface of the ITM 210. Examples of fabric-containing layer are illustrated in FIGS. 2A-2B (e.g. fiberglass which is optionally impregnated with and/or coated with silicone). For example, a thickness of fabric-containing layer 480 is between 75 and 300 μm.
B. a compliance layer 420 which may configured to enable an image transfer surface of a release layer of an intermediate transfer member to conform and adapt to the topography of a substrate surface and increases the area of the intermediate transfer member that can be in close proximity to a substrate during impression (the transfer of the residue film to the substrate), thereby improving ink film residue transfer.

A compliance layer 420 is made of any suitable (typically compliant) material or combination of materials, having mechanical properties suitable for the operability of the intermediate transfer member. In some embodiments, a compliance layer is of a material selected from the group consisting of silicone rubber, acrylic rubber (ACM), cured acrylic rubber, hydrogenated nitrile butadiene rubber (HNBR), or combinations thereof.

In some embodiments, a compliance layer 420 has a hardness in the range of from 20 to 65 Shore A.

For example, the thickness of a soft compliance layer 420 ranges from about 50 μm to about 1000 μm.

The compliance layer 420 may be made of silicone material (e.g. Polydimethylsiloxane (PDMS) such as a vinyl-terminated PDMS. Collectively, the one or more compliance layers may have a thickness of between 100 and 400 μm. In the example of FIG. 2A, IR layer 412 (discussed below) also functions as an additional compliance layer (e.g. compliance layer include a black additive pigment), and the collectively thickness of IR layer and compliance layer 420 is about 300 μm.

In embodiments of the invention, the ‘compliance layer’ serves the functioning of mediating (i.e. directly or indirectly) between paper layer 600 and release layer 410 and promoting adhesion therebetween—thus, the ‘compliance layer’ 420 may also be considered an ‘adhesion layer.’

In some embodiments, there may be multiple ‘compliance’ and/or adhesion layers stacked on each other (e.g. in the region above the paper layer and below the release layer).

Any time a ‘compliance layer’ is disclosed herein, it may be replaced with an ‘adhesion layer’ and vice versa. This is because such a ‘mediating layer’ (e.g. silicone-based) between layers may have two functions—as an adhesive and to provide a certain amount of ‘softness’for compliance and/or conforming.
C. an IR layer 412 (e.g. disposed directly beneath release layer) for absorbing or attenuating a majority (e. g at least 70% or at least 80% or at least 90% or substantially all) of IR and/or near-IR radiation which passes through release layer 410.

For example, IR layer 412 may attenuate substantial intensity of light at selected wavelengths from being transmitted therethrough and/or from being reflected therefrom.

It will be understood that the level of attenuation depends on various parameters, such as layer thickness and wavelength of the light emitted by the sensing assembly. For example, UV wavelengths (e.g., about 10 nm-400 nm) may have larger attenuation compared to visible light (400 nm-700 nm) and infrared (IR) wavelengths (e.g., about 700 nm-1 mm).

In some embodiments, the IR layer comprises a matrix made from silicone (e.g., polydimethylsiloxane PDMS such as a vinyl-terminated PDMS) and multiple particles disposed at given locations within the bulk of the PDMS matrix of the IR layer. In some embodiments, the particles comprise a suitable type of additive pigment, such as but not limited to off-the-shelf carbon black (CB) particles, each of which having a typical diameter range between about 10 μm (for an IR layer having a thickness of about 30 um) and 30 μm (for an IR layer having a thickness of about 50 μm).

In some embodiments, the particles are embedded at the bulk of the IR layer, within a distance of about 10 μm or 20 μm from the aforementioned surface of the IR layer. The particles are also arranged uniformly along the IR layer at a distance of about 0.1 μm-5 μm from one another. In other embodiments, the distances to the surface and between the particles of the IR layer may be altered between different blankets, for example, at least one particle may be in close proximity or in contact with any of the surfaces of the IR layer.

Additional embodiments related to the IR layer 412, and the fabrication of ITM 412 having the IR layer 412 as described above, are described in more detail in PCT International Publication WO 2021/105806, whose disclosure is incorporated herein by reference.

If the IR layer 412 is relatively “thick” it may also function as a compliance layer 420 (see FIGS. 2A-2B).

Alternatively, ITM may lack any compliance layer 420 other than IR layer 412.
D. Adhesion layer 422—may be made from PDMS or any other suitable material, which is formed together with a fabric layer 480 (e.g. woven fiberglass layer).
   External layers—The ITM of FIGS. 1A-1B Comprises Two “External Layers”: (i) Release Layer 410 and (ii) Conductive Grip Layer 490, Which are Both Discussed Below.
A. Release layer 410 (e.g. hydrophobic and/or formed of silicone—e.g. addition-cured silicone) has an ink-reception surface (e.g. upper surface of 410) onto which ink droplets (e.g. droplets of aqueous ink) are deposited during a printing process-e.g. to form an ink image on the ink-reception surface of 410.

For example, said ink reception surface is adapted to satisfy one or more (i.e. any combination of) of the following structural properties:
(i) a receding contact angle of a droplet of distilled water on said ink reception surface is at most 60°; and/or
(ii) for a droplet of distilled water deposited on said ink reception surface, a 10 second dynamic contact angle (DCA) is at most 108°.

Release layer 410 may have at least one of the following structural properties:
(1) said addition-cured silicone material consisting essentially of an addition-cured silicone, or containing, by weight, at least 95% of said addition-cured silicone;
(2) functional groups make up at most 10% or at most 7.5% or at most 5% or at most 4% or at black most 3%, by weight, of said addition-cured silicone material.

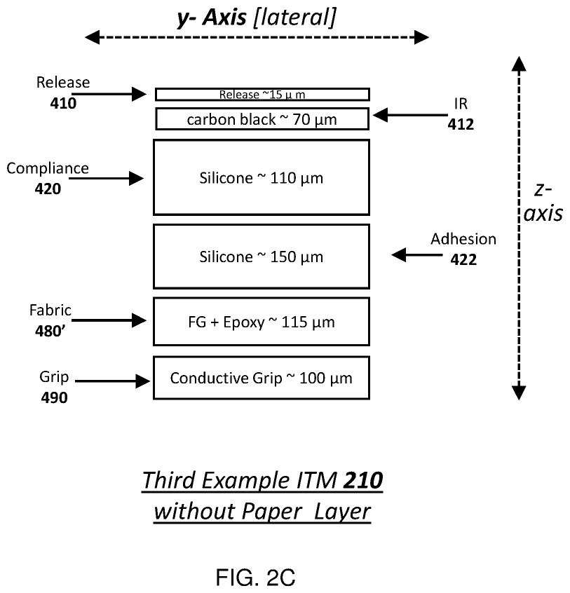

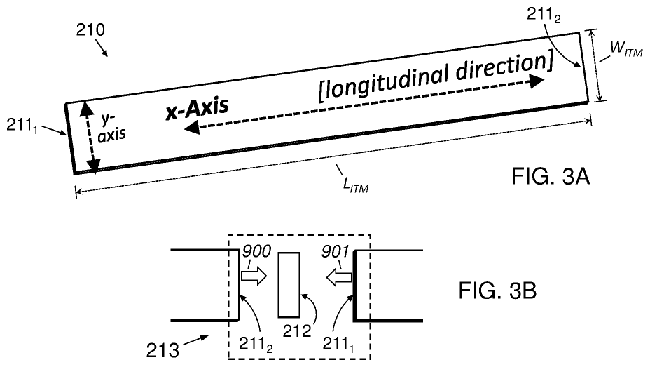

Release layer 410 (i.e. of any embodiment of the invention) may have any feature of any combination of features of release layers disclosed in PCT/IB2017/053167 incorporated herein by reference. This statement applies, for example, to any embodiment where ITM 210 comprises both a paper-based layer 600 and a fabric (e.g. glass-fabric or cotton fabric or ceramic fabric or polyester fabric) layer (see for example FIGS. 2-3) as well as to embodiments where the ITM 210 lacks any fabric or fiberglass layer (see for example FIGS. 4A-4B).
B. Grip layer 490—In some embodiments, the grip layer has a high-friction surface, and is configured to make physical contact between the blanket and a blanket module having rollers and other components for moving the blanket in the revolutions described above. In some embodiments, the grip layer 490 comprises a matrix made from: (i) a flexible material, such as silicone or any other suitable material(s), and (ii) electrically conductive additives, such as but not limited to carbon nanotubes (CNTs), which are embedded in the silicone matrix and are configured to improve the electrical conductivity of the grip layer.

As described above, when the blanket is moved by the blanket module, the friction between the grip layer and components of the blanket module (e.g., rollers and dancers of the printing system), may cause unintentional and undesired electrostatic charging of the blanket. In some embodiments, the improved electrical conductivity of the grip layer, which is obtained by implementing the embedded CNT additives in the silicone matrix, reduces and typically eliminates the charging effect, and thereby, preventing damage to the printing system and distortion(s) in the printed images.

The specific thicknesses listed above should be seen as exemplary and not as limiting.

### A Discussion of FIGS. 3A-3B

In some embodiments the ITM has the form factor of an elongated strip where ends thereof are connected (or connectable) to each to convert the strip into a closed loop or belt. The elongated strip (or loop or belt) define two directions-(i) a “longitudinal” or “print direction” corresponding to the elongate axis of the strip or a circumferential direction of the loop of belt and the “lateral ”or “cross-print direction” which is perpendicular to the “print direction.”

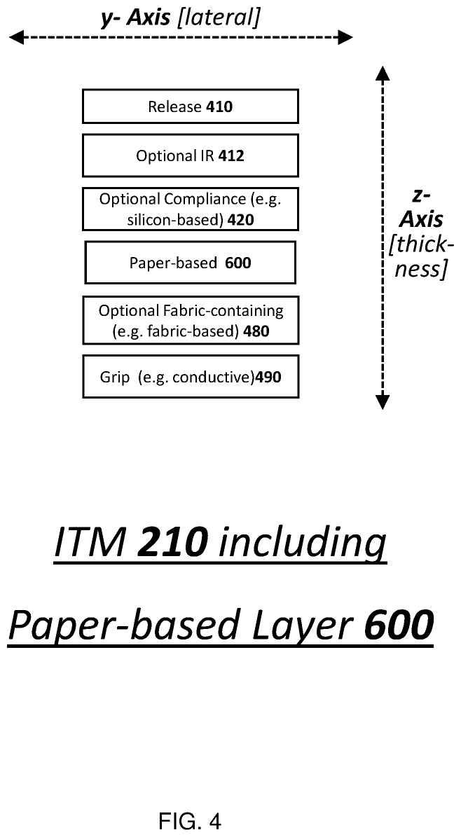

FIGS. 3A-3B are relevant both to ITMs lacking a paper-based layer (see FIGS. 1A-1B, 2A-2C) and also to ITMs that include one or more paper-based layers (see FIGS. 5, 6A-6B, 7A-7B, 8).

Reference is now made to FIG. 3A, which is a top perspective view of an intermediate transfer member (ITM) 210 according to embodiments of the invention. As seen in FIG. 3A, the ITM is initially an elongate rectangular strip, having a length indicated by L_{ITM} and a width indicated by W_{ITM}, the length being significantly greater than the width. In the initial, planar, configuration of the ITM, the ITM includes first and second ends, indicated by reference numerals 211₁ and 211₂. As described in further detail hereinbelow, ITM 210 may include a plurality of layers, disposed one above the other, such that only the upper layer of ITM 210 is visible in FIG. 5A.

Reference is now additionally made to FIG. 3B, which is a schematic illustration of ends 211₁ and 211₂ of ITM 210 of FIG. 3A being joined to form a seam, according to embodiments of the invention.

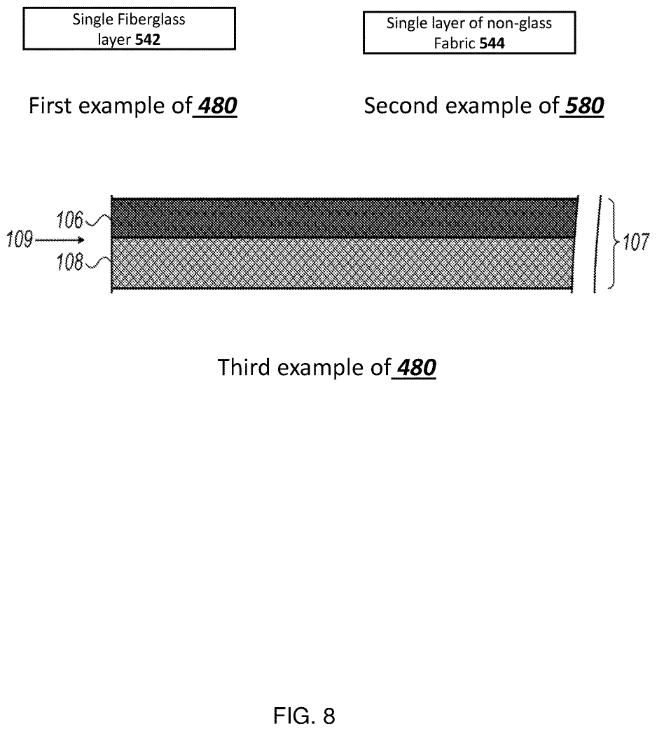

As seen in FIG. 3B, ends 211₁ and 211₂ of ITM 210 may be jointed together to form a continuous blanket loop, for example during installation of ITM 210 in a printing system, such as the printing system shown and described hereinbelow with respect to FIGS. 9A-9E. In the illustrated embodiment, the ends of ITM 210 are adhered edge-to-edge by taping the ends of the ITM using a tape strip 212, which overlaps both ends of the ITM. The tape strip 212 may include Kapton® tape, Room-Temperature-Vulcanizing silicone (RTV) liquid adhesives, or thermoplastic adhesives. During adhering of the ends 211 of ITM 210 to each other, the ends 211₁ and 211₂ are moved toward each other in the directions of arrows 900 and 901, respectively. The area of ITM 210, covered by tape strip 212, is indicated by the dashed rectangle 213.

Any method of joining the ends of blanket 210 may cause a discontinuity, referred to herein as a seam, and it is desirable to avoid an increase in the thickness or discontinuity of chemical and/or mechanical properties of blanket 210 at the seam. Examples of methods and systems for the installation of the seam are described in detail in PCT International Publication WO 2019/012456 and in US Patent Application Publication No. 2020/0171813, whose disclosures are incorporated herein by reference

### A Discussion of FIGS. 4-8

In contrast to the ITMs of FIGS. 1-3 which each lack a paper-based layer, the ITMs in FIGS. 2-4 each include a paper-based layer 600 comprising paper and/or paper fiber. For example, the paper-based layer 600 includes at least 50%, at least 60%, at least 70%, at least 80%, or at least 90% paper fiber or 100% paper fiber.

For any embodiment disclosed herein, paper-based layer 600 may optionally be coated with a material such as epoxy (e.g. epoxy resin) (e.g. cured epoxy such as cured epoxy resin) or silicone. Alternatively or additionally, for any embodiment disclosed herein, paper-based layer 600 impregnated with a material such as epoxy (e.g. epoxy resin) (e.g. cured epoxy such as cured epoxy resin) or silicone. The curing may be useful for providing the ITM with additional tear resistance.

### For the Present Disclosure, If:

(i) a paper-based layer of an ITM is ‘impregnated with a substance’ or ‘coated with a substance’ (e.g. epoxy or epoxy resin—e.g. cured) and
(ii) a ‘presence of the ‘substance’ in or on the paper-based layer’ (i.e. due to impregnation and/or coating) contributes at least X% (X is as positive number less than 100) between of the given_physical_property of the ITM in the longitudinal direction (NOTE—the given_physical_property may be tear resistance or mutatis mutandis the given_physical_property may be tensile strength or mutatis mutandis the given_physical_property may be spring coefficient),
   this is defined to provide all of the following:
A: a ‘given_physical_property-difference in the longitudinal direction’ is defined as a difference between: (i) a given_physical_property of the ITM in the longitudinal direction; and (ii) a given_physical_property in the longitudinal direction of a similar ITM without the ‘substance’ (e.g. epoxy resin) present in the paper-based layer (i.e. the ‘non-impregnated and non-coated version’ of the paper-based layer)—i.e. the same exact ITM which is the same in every manner but with only a single modification—i.e. without a presence of the impregnating and/or the coating ‘substance’ in the paper-based layer so this ‘impregnating and/or coating substance’ (e.g. epoxy resin) is absent from the paper-based layer (i.e. no impregnation and no coating of the paper-based layer by the ‘substance’); and
B. a ratio between ‘given_physical_property-difference in the longitudinal direction’ and ‘given_physical_property’ in the longitudinal direction of the ITM is defined as ‘given_physical_property-ratio’;
C. 100*‘given_physical_property-ratio’ must equal or exceed X.

By way of example, consider an ITM whose paper layer is impregnated and/or coated with a substance. If a value of the given_physical_property in the longitudinal direction that ITM is 120 (i.e. where the paper-layer of the ITM is impregnated and/or coated with the substance), and a value of the given_physical_property in the longitudinal direction for ‘non-impregnated version’ of the ITM (i.e. where the paper layer is not impregnated and not coated with the substance) is 100, then we can say the following: (i) the ‘given_physical_property-difference in the longitudinal direction’ is 120−100=20; and (ii) the ratio between ‘given_physical_property-difference in the longitudinal direction’ and ‘given_physical_property’ in the longitudinal direction of the ITM is 20/120=0.1666. In this case, ‘given_physical_property-ratio’ is equal to 0.166666. We may thus say the “presence of” the substance in the paper-based layer contributes at least 5% (since 100*0.166 equals or exceeds 5) or at least 10% (since 100*0.166 equals or exceeds 10) or at least 16% (but NOT at least 17% and NOT at least 20%) to the ‘given physical property’ in the longitudinal direction of the ITM. In the examples of FIGS. 4-8 additional layers may be present in other embodiments, and also one or more layers of any illustrated ITM may be omitted.

Release Layer 410 of any of FIGS. 4-8 (or of any ITM comprising a paper layer) may have any feature described above with respect to the release layer 410 in the context ITMs lacking a paper-based layer (see discussion above with reference to FIGS. 1-2)

IR Layer 412 (if present) of any of FIGS. 4-8 (or of any ITM comprising a paper layer) may have any feature described above in the context ITMs lacking a paper-based layer (see discussion above with reference to FIGS. 1-2). Alternatively or additionally, paper-based layer (or an upper surface thereof) is black.

Grip layer 690 of any of FIGS. 4-8 (or of any ITM comprising a paper layer) may have any feature described above with respect to the grip layer 490 in the context ITMs lacking a paper-based layer (see discussion above with reference to FIGS. 1-2).

FIGS. 5A-5B, 6A-6B, and 7A-7B are specific examples of the ITM of FIG. 4.

In the example of FIGS. 5A-5B, the fabric layer 480″ is a glass fabric such as fiberglass (e.g. woven fiberglass). For example, the fabric layer 480″ (which would absorb surface roughness—see for example, ‘condition C’ discussed above in the summary section). This may obviate or eliminate the need (i.e. required thickness of) for a silicone-based compliance layer, thereby reducing the thermal mass of the ITM.

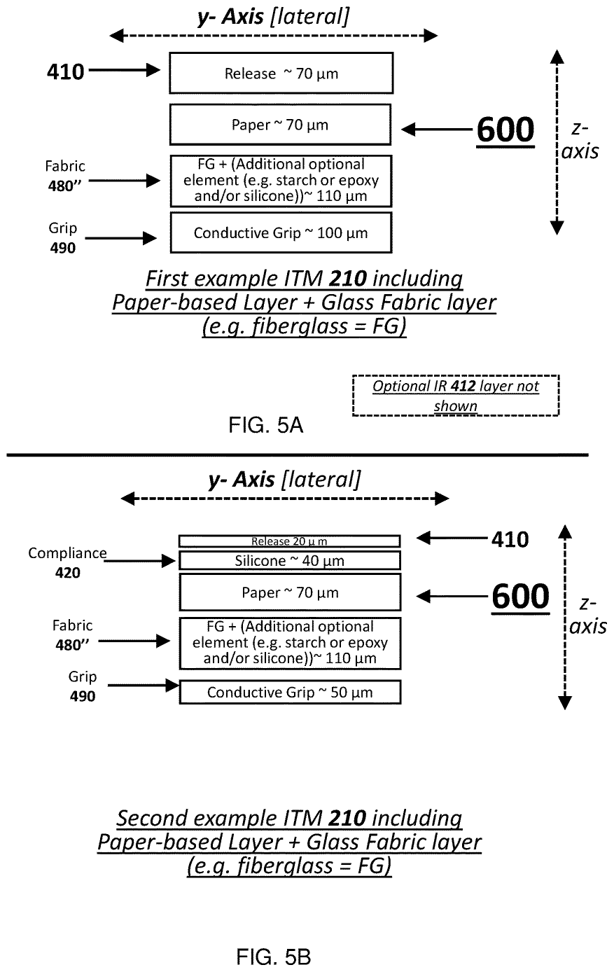

In the example of FIGS. 6A-6B, the fabric layer 480″ is a non-glass fabric such as a cotton or polyester or ceramic fabric. Once, use of paper as an internal layer 600 of the ITM may obviate or eliminate the need (i.e. required thickness of) for a silicone-based compliance layer, thereby reducing the thermal mass of the ITM.

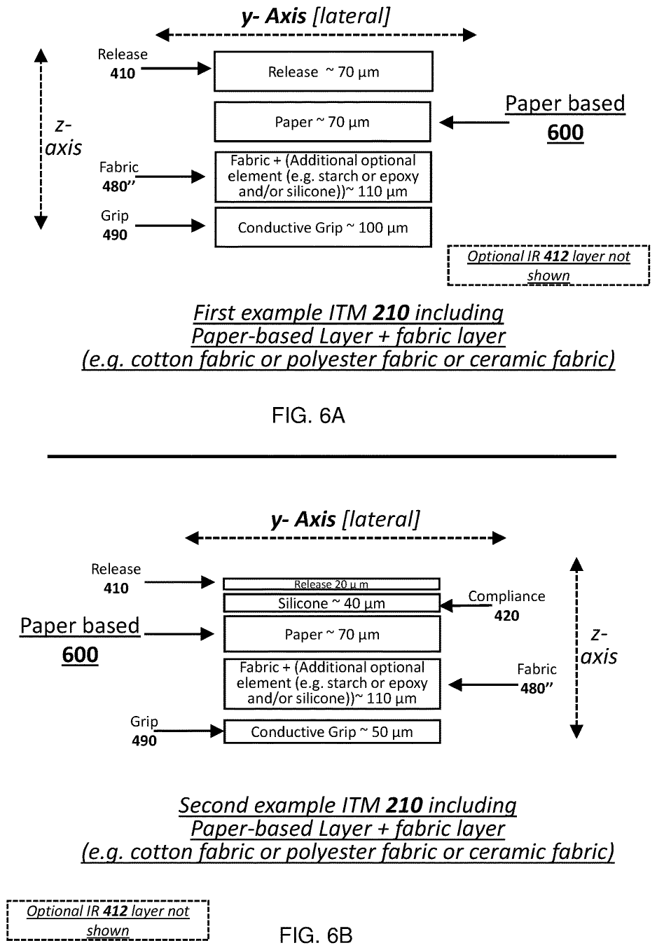

In the example of FIGS. 6A-6B and 7A-7B, the ITM lacks any fabric layer. For example, the ITM may lack any fabric layer but the paper-based layer may be the epoxy-resin-impregnated. For example, a presence of the epoxy in the epoxy-resin-impregnated paper-based layer contributes at least 10% or at least 20% or at least 30% or at least 40% or at least 50% to the tensile strength of the ITM in the longitudinal direction. Alternatively or additionally, a presence of the epoxy in the epoxy-resin-impregnated paper-based layer contributes at least 10% or at least 20% or at least 30% or at least 40% or at least 50% to the tear resistance of the ITM in the longitudinal direction.

Thus, FIGS. 5A-5B relate to relate to intermediate transfer members (ITM) comprising both a paper-based layer and a glass-fabric layer according to embodiments of the invention.

One salient feature of the ITMs of FIGS. 5A-5B is the combination of a glass-fiber layer 480″ and a paper layer 600—as illustrated in the drawings, the paper layer 600 is above the fiberglass layer 480″. This is not a requirement (i.e. alternatively or additionally, a paper layer 600 is disposed below fiberglass layer 480″—or below any non-glass fabric layer). Nevertheless, in the illustrated geometry where the paper layer 600 is above the fiberglass layer 480″ (i.e. as illustrated in FIGS. 5A-5B), a presence of the paper layer 600 above fiberglass layer may serve to cushion a roughness of the upper surface of the fiberglass layer 480″.

For example, a ratio between a surface roughness of the ITM upper surface (i.e. upper surface of release layer 410) and a surface roughness of an upper surface of any fiberglass-based layer 480″ is at most 0.2 or at most 0.1 or at most 0.05.

In some embodiments (e.g. related to FIGS. 2A-2B), (A) at least 30% or at least 40% or at least 50% or at least 60% or at least 70% or at least 80% or at least 90% of) (at least a majority of) the ITM's stiffness is provided by the paper-based layer 600, while (B) at least 30% or at least 40% or at least 50% or at least 60% or at least 70% or at least 80% or at least 90% of) (at least a majority of) the ITM's tear resistance is provided by the fiberglass layer 480″.

Additional material may be present within any fabric-based layer such as a glass-based fabric fiberglass (e.g. FIGS. 2A-2B) or in any fabric layer 370 (e.g. of FIGS. 3A-3B) which is not necessarily glass-based (e.g. ceramic fabric or polyester fabric or cotton fabric). Examples of additional material include starch and/or epoxy and/or silicone.

An ITM 210 such as that illustrated in FIGS. 2A-2B may have a tensile strength of at least 75 N and/or at most 250 N (Newtons) in the longitudinal direction (i.e. print direction) and at least 75 N and/or at most 250 N (Newtons) in the lateral direction (i.e. cross print direction).

An ITM 210 such as that illustrated in FIGS. 2A-2B may have a spring constant of at least 20 and/or at most 100 N/mm (Newtons per millimeter) in the longitudinal direction (i.e. print direction). Alternatively or additionally, the ITM may have a spring constant of at least 20 and/or at most 80 N/mm (Newtons per millimeter) (e.g. at most 60 N/mm) in the lateral direction (ie. cross print direction)

ITMs of FIGS. 3A-3B are like those of FIGS. 2A-2B where fiberglass layer 380″ is replaced with fabric layer 370.

Fabric layer 370 may be fashioned from any suitable fibers, twisted or non-twisted. The fibers may be in any suitable form including monofilaments, grouped filaments and yarns. In embodiments including a yarn, the yarn may be of a single type of fiber, or a blend of two or more different types of fibers. In some embodiments, at least some of the fibers (and in some embodiments, substantially all of the fibers) making up a given layer of fabric are selected from the group consisting of meta-aramide polymers (e.g., Nomex® fibers), para-aramide polymers (e.g., Kevlar® fibers), ceramic-based fibers, basalt fibers, nylon-based fibers, twisted nylon based fibers, cotton-based fibers, twisted cotton-based fibers, polyester-based fibers, twisted polyester-based fibers, glass-based fibers, carbon-fiber (graphite) based fibers, and metal-based fibers, or a combination thereof. In some embodiments, all of the layers of fabric are of the same fiber or combination of fibers. In some embodiments, at least one layer of fabric is of substantially different fiber composition.

In the example of FIGS. 4A-4B, the ITM lacks any fabric layer.

An ITM 210 such as that illustrated in FIGS. 4A-4B may have a tensile strength of at least 20 N (Newtons) and/or at most 80 N (Newtons) in the longitudinal direction (i.e. print direction) and about at least 20 N (Newtons) and/or at most 50 N (Newtons) in the lateral direction (i.e. cross print direction).

An ITM 210 such as that illustrated in FIGS. 4A-4B may have a spring constant of at least 20 and/or at most 100 N/mm (Newtons per millimeter) in the longitudinal direction (i.e. print direction) and at least 10 and/or at most 60 N/mm (Newtons per millimeter) in the lateral direction (ie. cross print direction)

In different embodiments, paper layer 600 is black or has a black upper surface (e.g. for absorbing electromagnetic radiation incident thereon during the printing process so as to heat-evaporate liquid present on an upper surface of ITM 210). Alternatively or additional, one or more layers above paper-based layer 600 (e.g. below release layer 410) is black or comprises black material such as carbon black (e.g. disposed in a silicone matrix). For example, such a layer may provide in accordance with any teaching or combination of teachings disclosed in any of the following patent applications, each of which are incorporated herein by reference: PCT/IB2016/057226 which published as WO 2018/100412, PCT/IB 2017/057556 which published as WO 2018/100541, PCT/IB 2017/057557 which published as WO 2018/100542, PCT/IB 2017/057542 which published as WO 2018/100530, and PCT/IB 2017/057535 which published as WO 2018/100528.

For example, a layer comprising a silicone matrix and a carbon black may be present.

At this point a discussion related to the ability of the ITM upper surface to remain smooth and/or related to thermal expansivity of one or more layers of ITM 210 is provided.

### Features Related to (i) Having Retaining a ITM Upper Surface Even After Multiple Heating/Cooling Cycles and/or (ii) Thermal Expansion of Layers of ITM 210

Any presently disclosed ITM 210 may be used in a printing process where the temperature on the surface of the blanket fluctuates during the process. For example, after ink droplets are deposited on the upper surface of the ITM, this upper surface is heated to a maximum temperature T_{MAX} (e.g. at least 100° C., at or at least 110° C., at least 120° C., or at least 130° C.) and is subsequently cooled to a ‘transfer temperature’ T_{TRANSFER} (i.e. T_{MAX}>T_{TRANSFER}) where an ink image present on the ITM upper surface is transferred therefrom to substrate (e.g. T_{MAX}>T_{TRANSFER}≥20° C. or T_{MAX}>T_{TRANSFER}≥40° C. or T_{MAX}>T_{TRANSFER}≥50° C.).

In embodiments of the invention, both of the following features are provided:
(i) the upper surface of ITM 210 (e.g. upper surface of layer 410) is very ‘smooth’ such that an average surface roughness of an upper surface of the ITM is at most 10 μm, or at most 5 μm, or at most 3 μm, or at most 2 μm, or at most 1 μm or at most 0.5 μm or at most 0.25 μm; and (ii) this aforementioned ITM-upper-surface-smoothness (i.e. roughness of at most 10 μm, or at most 5 μm, or at most 3 μm, or at most 2 μm, or at most 1 μm, or at most 0.5 μm or at most 0.25 μm) is retained even after usage as discussed below.

This “usage” may be defined in terms of heating/cooling events—i.e. after a number of heating/cooling events where the upper surface of ITM 410 is heated and then cooled before the next heating/cooling events.

Thus, in embodiments of the invention, this aforementioned ITM-upper-surface-smoothness (i.e. roughness of at most 10 μm, or at most 5 μm, or at most 3 μm, or at most 2 μm, or at most 1 μm, or at most 0.5 μm or at most 0.25 μm) is retained even multiple (e.g. at least 2 or at least 10 or at least 100 or at least 1000 or at least 5000 or at least 10,000 or at least 50,000 or at least 100,000) 2+-second heating(120+° C.)/4+-second cooling (90−° C.) events.

For the present disclosure, an W+-second heating (X+° C.)/Y+-second cooling (Z−° C.) events (W, X, Y and Z are all positive numbers) is defined as a heating/cooling event wherein: (i) the upper surface of the ITM is maintained at or above a ‘hotter temperature’ T_{HOTTER} (e.g. for T_{HOTTER}=120° C.) at least for at least W seconds (e.g. for at least 1 second or at least 2 second or at least 3 seconds or at least 5 seconds) and (ii) subsequently maintained at or below a ‘colder temperature’ T_{COLDER} (e. g T_{COLDER}=90° C.) at least for at least Y seconds (e.g. at least 1 at least 2 or at least 5 or at at least 10 seconds).

Thus, in embodiments of the invention, the surface roughness of an upper surface of the ITM is at most 1 μm, or at most 0.5 μm or at most 0.25 μm or at most 0.2 um or at most 0.15 μm or at most 0.1 μm) even after the upper surface of ITM 210 is subjected to multiple (e.g. at least 2 or at least 10 or at least 100 or at least 1000 or at least 5000 or at least 10,000 or at least 15,000 or at least 50,000 or at least 100,000) 2+-second heating(120+° C.)/4+-second cooling (90−° C.) events.

Not wishing to be bound by theory, it is has been found that including an interior layer having a ‘high’ coefficient of thermal expansion might lead to a situation where the upper surface of the ITM loses its smoothness after many heatings and coolings—e.g. such an interior layer might cause ‘bulging’(or uneven bulging).

In different embodiments of the invention, the ITM is characterized by an absence of any interior layer of the ITM (i.e. layers below the upper ink-reception surface or layers) having a ‘significant’ thermal Coefficient of Linear Thermal Expansion (CLTE)—this may be characterized in terms of the 100° C. CLTE (i.e. the CLTE at 100° C.). Unless denoted otherwise, any reference herein to CLTE relates to 100° C. CLTE. We note that CLTE is a directional-property, especially for materials e.g. it is known that the CLTE for wood perpendicular to the grain is significantly exceeds the CLTE parallel to the wood grain. A “maximum CLTE” direction of an item is the direction for which the CLTE has its maximum value—e.g. for many woods this would be the perpendicular of the wood grain. A “minimum CLTE” direction of an item is the direction for which the CLTE has its minimum value—e.g. for many woods this would be the parallel of the wood grain. A “direction-maximized CLTE” of an item is the CLTE of the item in its maximum CLTE direction. A “direction-minimized CLTE” of an item is the CLTE of the item in its minimum CLTE direction.

As noted above, in some embodiments, the ITM is characterized by an absence of any interior layer of the ITM (i.e. layers below the upper ink-reception surface or layers) having a ‘significant’ CLTE. In some embodiments, the ITM is characterized by lacking an interior layer whose direction-maximized value exceeds 10*10⁻⁶ meter/(meter ° C.). In some embodiments, the ITM is characterized by lacking an interior layer whose direction-maximized CLTE value is at least 15*10⁻⁶ meter/(meter ° C.). In some embodiments, the ITM is characterized by lacking an interior layer whose direction-maximized-CLTE value is at least 20*10⁻⁶ meter/(meter °0 C.).

Note—by way of example, in FIG. 2A layers 410 and 490 are exterior layers while layer 600 and 480″ are interior layers; in FIG. 2B layers 410 and 490 are exterior layers while layers 412, 600 and 480″ are interior layers.

In some embodiments, paper-based layer 600 is the only interior layer of the ITM.

Alternatively, in some embodiments the ITM comprises one or more additional layers other than the paper-based layer such that: for every given interior layer of the ITM other than the paper-based layer, a ratio between (i) direction-maximized Coefficient of Linear Thermal Expansion CLTE of the given interior layer of ITM; and (ii) a direction-maximized Coefficient of Linear Thermal Expansion CLTE of the paper-based layer 600 is at most 5 or at most 4 or at most 3 or at most 2 or at most 1.5

### Additional Discussion of FIGS. 4A-4E

The present inventors are now describing a multi-layer intermediate transfer

In embodiments of the invention, ITM 210, or blanket, used in a printing system, is sufficiently strong to endure printing at high speeds for extended durations, without causing wear to the blanket which would result in damage to the ITM, the printing press, or the printed matter. This is particularly true in printing systems in which the ITM is disposed over rollers and is in constant friction therewith. At the same time, the ITM may also be suitable for an efficient printing process, e.g. having a release layer which easily releases the ink onto the printed matter.

In some embodiments of the present invention, the ITM includes a release layer, suitable for release of the ink as required for efficient printing, and a paper, or paper-including, layer, which provides the sufficient strength and durability to the ITM.

In the context of the present invention and in the claims, the terms “blanket” and “intermediate transfer member (ITM)” are used interchangeably and refer to a flexible member comprising a stack of layers used as an intermediate member configured to receive an ink image and to transfer the ink image to a target substrate, as will be described in detail below

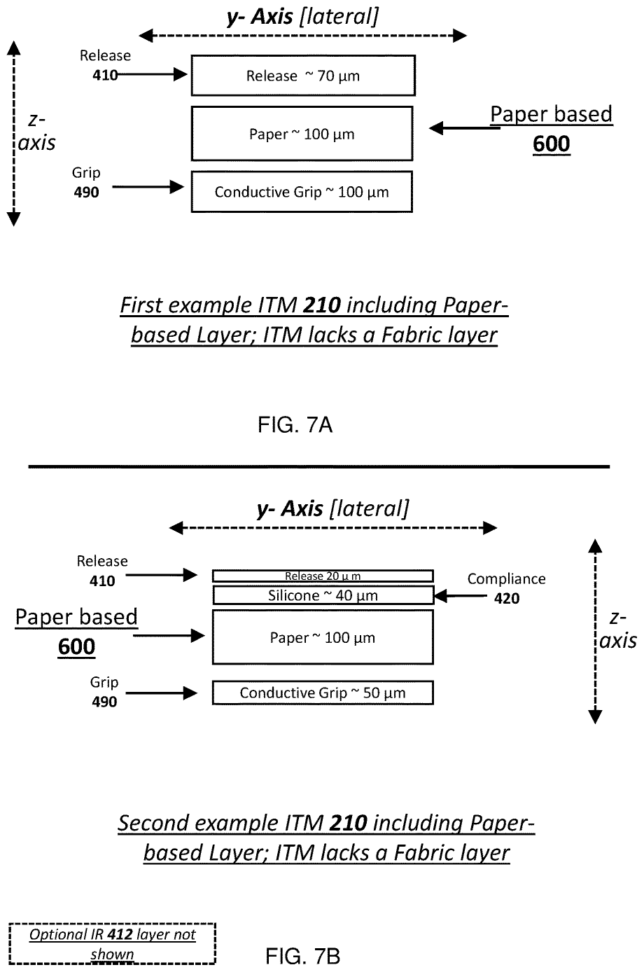

FIG. 8 shows three examples of fabric-based layer 480. For example, fabric based layer stack 480 may be a single layer 542 of fiberglass. Alternatively, fabric based layer stack 480 may be a single layer 544 of non-glass fabric.

Another “third” example is the stack 107 of flexible support layers shown at the bottom of FIG. 8. The stack 107 includes elements 106, 109 and 108—fabric based layer stack 480 may be a single layer 542 of FIG. 8 respectively correspond the elements 106, 109 and 108 of FIG. 2 of U.S. provisional application 63/296,173 filed on Jan. 4, 2022, incorporated herein by reference in its entirety.

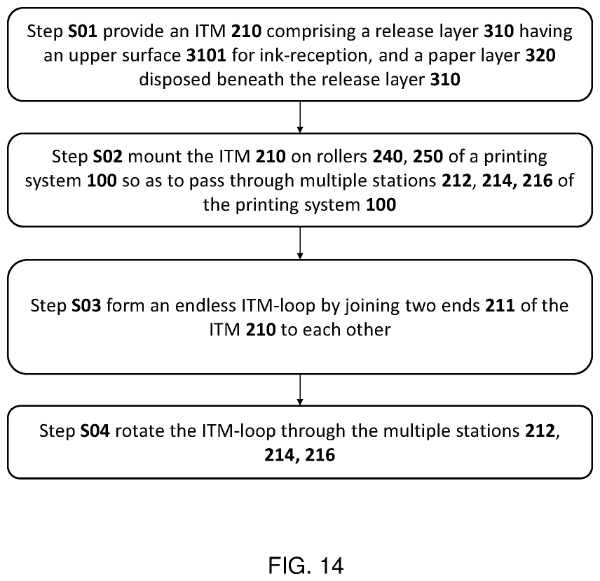

Thus, shown at the bottom of FIG. 8 (i.e. third example of FIG. 480) reinforcement stacked layers, also referred to herein as a stack of flexible support layers 107 or a skeleton of ITM 210, which are coupled to compliance layer 104 and are described in detail below. In some embodiments, support layers 107 are configured to provide ITM 210 with the required flexibility in XYZ axes, and yet, with an improved mechanical resistance to deformation or tearing (mainly in X-axis, but also in Y-axis) that may be caused by the torque applied to ITM 210, e.g., by BCD 77, BTD 99, and dancer assembly 74.

In some embodiments, support layers 107 of ITM 210 comprise a mesh 109, which is made from a woven fiberglass fabric, or from any other suitable material(s), which is configured to be flexible in XYZ axes, and yet, with a larger mechanical resistance to deformation compared to that of the silicone-based layers of ITM 210, such as layers 102 and 104. The resistance to deformation, also referred to herein as rigidness or stiffness of the respective layer, is measured using the testing procedure described above, and has a metric referred to herein as the elastic modulus whose measurement 7and calculation are described above.

In some embodiments, mesh 109 of support layers 107 has a typical thickness (measured in Z-axis) between about 90 μm and 120 μm, and has first and second sections, which are impregnated with layers 106 and 108, respectively, and are described herein. Note that both layers 106 and 108 are formed together with the woven fiberglass fabric of mesh 109, and the impregnation of mesh 109 and other processes are described in detail in U.S. provisional application 63/296,173 filed on Jan. 4, 2022, incorporated herein by reference in its entirety.

In some embodiments, layer 106, also referred to herein as an adhesion layer, is made from PDMS or any other suitable material, and has a typical thickness (measured in Z-axis) between about 20 μm and 50 μm, or any other suitable thickness.

In some embodiments, layer 108, is made from epoxy (e.g., C₂₁H₂₅ClO₅), also referred to herein as epoxy resin. In the present example, the epoxy resin is based on reaction products of bis-phenol A and epichlorohydrin, but in other embodiments, the epoxy resin maybe based on any other suitable molecules known in the art, which are produced using any suitable reactions.

For example, layer 108 is made from a RESOLTECH HTGL 210 product and a Hardener HTGL 216 product with some additives, which is supplied by Resoltech (ROUSSET 13790, France), but may comprise any other suitable product supplied by any other suitable supplier. Note that layer 108 has an elastic modulus (e.g., in direction 94 or in X-axis) different from, and typically larger than, the elastic modules of layer 106 in the same axis and/or direction. In other words, layer 108 is more rigid (i.e., stiffer) that layer 106.

In other embodiments, layer 108 is made from or any other suitable substance or compound of elements, such as but not limited to: Poly Aryl Ether Ketone (PAEK), starch also referred to herein as Polysaccharides, polyimide, Polyethylene Terephthalate. In yet other embodiments, layer 108 is made from any suitable combination of two or more of the above-listed substances that may also comprise the aforementioned epoxy.

In some embodiments, layer 108 has a typical thickness (measured in Z-axis) of about 50 μm, or any other suitable thickness, such that a combination (i.e., the sum) of the thicknesses of layers 106 and 108 is approximately equal to the thickness of mesh 109. Note that layers 106 and 108 are typically placed in contact with one another. In some cases the adhesion between materials selected for layers 106 and 108 is not sufficiently-high for bonding between layers 106 and 108. In such embodiments, the reinforcement of mesh 109 retains layers 106 and 108 is contact with one another. In alternative embodiments, the materials selected for layers 106 and 108 may have sufficiently-high mutual adhesion, or a third section of mesh 109 may be impregnated in an additional suitable intermediate layer that may be used for bonding between layers 106 and 108.

In other embodiments, the sum of the thicknesses of layers 106 and 108 may differ from the thickness of mesh 109, for example, when an additional section of mesh 109 is impregnated in one or more additional layer(s). In yet other embodiments, mesh 109 may be impregnated only in a single layer, such as layer 108, which is stiffer than one or more of the silicone-based layers of ITM 210.

In alternative embodiments, layer 106, which is typically used for bonding between layers 108 and 104, may be removed from the configuration of ITM 210. In such embodiments, the section of mesh 109 that was impregnated in layer 106, may now be impregnated in at least a section of layer 104. In other words, a section of mesh 109 may be impregnated in a portion of layer 104.

In other embodiments, instead of stack 107, the blanket may comprise mesh 109 being fully impregnated in the PMDS (and/or any other suitable materials and/or variations of the PMDS described above) of layer 106. In other words, in this support layer, the entire size (along the Z-axis) of the woven fiberglass fabric of mesh 109, is impregnated in the PMDS, and does not have the epoxy or other substances of layer 108 as described above. In such embodiments, the typical thickness (measured along the Z-axis) of mesh 109 and layer 106 is between about 50 μm and 200 μm.

In some embodiments, the different configurations of the stack of flexible support layers 107 were tested using the testing procedures described above. Moreover, the different configurations were also characterized using additional types of testing. The various configurations are based on selected materials and thickness of the aforementioned layers, so as to obtain a set of different mechanical properties of ITM 210. For example, the spring constant calculated in the test performed using the Lloyd system is between about 20 and 50 when using only silicone-based (e.g., PMDS) layers in ITM 210, whereas when the same testing procedure is applied to ITM 210 having layer 108 made from epoxy (as shown in FIG. 2) or starch, the calculated spring constant is between about 70 and 120. In other words, the spring constant of ITM 210 is about 3-times higher when using epoxy or starch in layer 108.

In an embodiment, based on the characterization and the requirements of the printing application, a user of system 10 may select a suitable configuration of ITM 210 from among the above-described example configurations of ITM 210. Note that selecting the most suitable configuration, provides the user with improved quality of the printed images obtained by improving the stability of the blanket dimension. For example, an optimal rigidness of ITM 210 reduces the level of C2C registration errors (e.g., when applying droplets 11 to surface 103), and also reduces the level of image-to-substrate error(s) (e.g., during the image transfer process). Moreover, obtaining an optimal stiffness of ITM 210 may also reduce the frequency of blanket replacement events, and therefore, improves the availability, utilization and output of images printed in system 10 during a predefined time interval (e.g., 24 hours).

In some embodiments, ITM 210 comprises a high-friction layer, also referred to herein as a grip layer 110, made from a typically transparent PDMS and configured to make physical contact between ITM 210 and the components of system 10 configured for moving ITM 210 in direction 94. In the present example, a list of the parts in contact with ITM 210 comprises at least rollers 76 and 78, BCD 77, BTD 99, and dancer assembly 74 described in FIG. 1 above. Note that ITM 210 may also have contact with parts of blanket treatment station 52. For the sake of description clarity, one or more of the parts described above are also referred to herein as “components” or “transfer components” that are placed in contact with ITM 210.

In some embodiments, although grip layer 110 is made from relatively soft materials (e.g., PMDS), an outer surface of ITM 210, also referred to herein as a surface 113, which is facing the transfer components, has high friction so that ITM 210 can withstand the torque applied, e.g., by BCD 77, BTD 99 and rollers 78, without sliding.

In some embodiments, grip layer 110 may have a thickness between about 90 μm and 120 μm, but may alternatively have any other suitable thickness.

In some cases, the friction between ITM 210 and one or more of the transfer components may produce undesired electrostatic charging in grip layer 110. The electrical conductivity of the PMDS and other variations of the silicone-based and epoxy-based layers of ITM 210 may trap the produced charge within ITM 210. The charge carriers of the trapped electrostatic charge are typically moving to the outer layers of ITM 210, in the present example, to grip layer 490 and to release layer 410.

FIG. 9A is a schematic elevation-view illustration of a printing system 100 according to embodiments of the invention. In some embodiments, system 100 comprises a rolling flexible blanket or ITM 210 that cycles through an image forming station 212, a drying station 214, an impression station 216 and a blanket treatment station 213.

In some embodiments, image forming station 212 is configured to supply various types of printing fluids, such as any suitable type of ink (e.g. inkjet ink), and/or liquid toner and/or colorant-containing slurries, and other liquids that include at least one colorant. The description below refers to aqueous ink but is also applicable for any other type of printing fluid.

In an operative mode, image forming station 212 is configured to form a mirror ink image, also referred to herein as “an ink image” (not shown), of a digital image on an upper run of a surface of blanket 210. Subsequently the ink image is transferred to a target substrate, (e.g., a paper, a folding carton, or any suitable flexible package in a form of sheets or continuous web) located under a lower run of blanket 210.

In the context of the present invention, the term “run” refers to a length or segment of blanket 210 between any two given rollers over which blanket 210 is guided.

In some embodiments, during installation thereof, ITM 210 may be converted from an elongate strip to a continuous blanket loop by soldering, gluing, taping with a connective strip overlapping both edges of the strip, or using any other suitable method.

In some embodiments, image forming station 212 comprises four separate print bars 222, connected to an ink supply system, each of which is configured to deposit one of four different colors, such as cyan (C), magenta (M), yellow (Y) and black (K). In other embodiments, station 212 may comprise any suitable number of print bars 222 arranged in station 212 at any suitable configuration and spacing therebetween. The ink supply system further comprises multiple ink reservoirs (not shown) configured to supply the cyan (C), magenta (M), yellow (Y) and black (K) aqueous ink to print bars 222. In other embodiments, the ink supply system may comprise more than one ink reservoir for each color, and optionally additional ink reservoirs for additional colors not mentioned above.

In some embodiments, each of print bars 222 incorporates one or more print heads configured to jet ink droplets of different colors onto the surface of blanket 210 so as to form the ink image (not shown) on the surface of blanket 210.

In some embodiments, print bars 222 are configured to deposit different shades of the same color, such as various shades of gray including black, or for two or more print bars 222 to deposit the same color, e.g., black.

In some embodiments, system 100 may comprise drying stations 224 that may be located between print bars 222 also referred to herein as intermediate drying stations (not shown) and/or after image forming station 212 as shown in FIG. 2. Drying stations 224 are configured to blow hot air (or another gas) onto the surface of blanket 210, so as to partially dry the ink image that is being formed. This hot air flow between the print bars may assist, for example, in reducing condensation at the surface of the print heads and/or handling satellites (e.g., residues or small droplets distributed around the main ink droplet), and/or in preventing blockage of the inkjet nozzles of the print heads, and also prevents the droplets of different color inks on blanket 210 from undesirably merging into one another. In some embodiments, each print bar 222 is configured to jet one or more droplets of the same color at a given location on blanket 210, so as to control the level of printed color at the given location. For example, one droplet of black ink may result in light grey printed color, whereas three droplets of black ink deposited on blanket 210 may result in dark grey or black color at the given location.

In drying station 214, the ink image formed on blanket 210 is exposed to radiation and/or hot air in order to dry the ink more thoroughly, evaporating most of the liquid carrier and leaving behind only a layer of resin and coloring agent which is heated to the point of being rendered tacky.

In impression station 216, blanket 210 passes between an impression cylinder 220 and a pressure cylinder 218, which is configured to carry a compressible blanket 219.

In some embodiments, system 100 comprises a control console (not explicitly shown), which is configured to control multiple stations and other components of system 100, such as the motion of blanket 210, image forming station 212, and other components described herein. In some embodiments, the console may include a processor, typically a general-purpose processor, with suitable front end and interface circuits for controlling, for example, the motion of blanket 210 and station 212, and for receiving signals therefrom. In some embodiments, the processor may be programmed in software to carry out the functions that are used by the printing system, and the processor stores data for the software in a memory. The software may be downloaded to the processor in electronic form, over a network, for example, or it may be provided on non-transitory tangible media, such as optical, magnetic or electronic memory media.

In some embodiments, the console also comprises a display (not explicitly shown), which is configured to display data and images received from the processor, or inputs inserted by a user (not shown) using input devices of system 100. In some embodiments, the console may have any suitable configuration, for example, a configuration of the console and the display is described in detail in U.S. Pat. No. 9,229,664, whose disclosure is incorporated herein by reference.

In some embodiments, system 100 comprises one or more electrical distribution boards (not explicitly shown), configured to electrically connect between the console and all the components, modules and stations of system 100. It will be understood that the configurations of the electrical cabling and routing of system 100 is simplified and depicted purely by way of example, and other suitable configurations can also be used.

In some embodiments, blanket treatment station 213, also referred to herein as a cooling station, is configured to treat the blanket by, for example, cooling it and/or applying a treatment fluid to the outer surface of blanket 210, and/or cleaning the outer surface of blanket 210. At blanket treatment station 213 the temperature of blanket 210 can be reduced to a desired value before blanket 210 enters, or re-enters, image forming station 212. The treatment may be carried out by passing blanket 210 over one or more rollers or blades configured for applying cooling and/or cleaning and/or treatment fluid on the outer surface of the blanket. In some embodiments, the processor is configured to receive, e.g., from temperature sensors (not shown), signals indicative of the surface temperature of blanket 210, so as to monitor the temperature of blanket 210 and to control the operation of blanket treatment station 213. Examples of such treatment stations are described, for example, in PCT International Publications WO 2013/132424 and WO 2017/208152, whose disclosures are all incorporated herein by reference. Blanket treatment station 213 may be mounted adjacent to blanket 210 at any suitable location between impression station 216 and image forming station 212.

Substrate sheets, or a continuous substrate web, are carried by a suitable transport mechanism (not shown) from a supply stack (not explicitly shown), and passed through a nip located between impression cylinder 220 and pressure cylinder 218. Within the nip, the surface of blanket 210 carrying the ink image is pressed firmly by compressible blanket 219 of pressure cylinder 218 against the substrate so that the ink image is impressed onto the surface of the substrate and separated neatly from the surface of blanket 210. Subsequently, the substrate is transported to an output stack (not explicitly shown).

In some embodiments, print bars 222 are positioned at predefined spacing from one another along a movement axis of blanket 210, represented by an arrow 2012. In some embodiments, system 100 further comprises various types of rollers, such as rollers 232, 240, and 250. In an embodiment, at least some of these rollers are controlled by the processor, so as to enable movement of blanket 210 at a desired (typically constant) speed below image forming station 212. Note that unsmooth or vibrating movement of blanket 210 may affect deposition of the ink image comprising one or more of the colors, and typically affect the accuracy of color-to-color registration.

In some embodiments, system 100 comprises two powered tensioning rollers, also referred to as dancers 250. Dancers 250 are configured to control the length of slack in blanket 210 before and after the nip. Furthermore, any stretching of blanket 210 with aging would not affect the ink image placement performance of system 100 and would merely require the taking up of more slack by tensioning dancers 250.

In some embodiments, a rotary encoder is incorporated into at least one of rollers 232 or 240, and dancers 250. The rotary encoder is configured to produce rotary-based position signals indicative of an angular displacement of the respective roller or dancer. The configuration and operation of rollers 232 and 240, and dancers 250, are described in further detail, for example, in U.S. Patent Application Publication 2017/0008272 and in the above-mentioned PCT International Publication WO 2013/132424, whose disclosures are all incorporated herein by reference.

In the example of FIG. 6, rollers 232 are positioned at the upper run of blanket 210 and are configured to maintain blanket 210 taut when passing adjacent to image forming station 212. Furthermore, it is particularly important to control the speed of blanket 210 below image forming station 212 so as to obtain accurate jetting and deposition of the ink droplets, thereby placement of the ink image, by forming station 212, on the surface of blanket 210.

In some embodiments, impression cylinder 220 is periodically engaged to and disengaged from blanket 210 to transfer the ink images from moving blanket 210 to the target substrate passing between blanket 210 and impression cylinder 220. In some embodiments, the periodic engagements induce mechanical vibrations within slack portions in the lower run of blanket 210. System 100 is configured to apply torque to blanket 210 using the aforementioned rollers and dancers, so as to maintain the upper run taut and to substantially isolate the upper run of blanket 210 from being affected by the mechanical vibrations in the lower run.

In some embodiments, blanket 210 comprises an encoder comprising one or more markers formed or engraved along the blanket. The markers may be distributed over blanket 210 in any suitable configuration or embedded within one or more of the blanket layers. Furthermore, the encoder may comprise, instead of or in addition to the markers, at least one continuous marker (not shown) formed along at least a portion of blanket 210. The continuous marker may be produced, for example, by jetting ink on top of, or between, the layers of blanket 210, or by using any other suitable technique as wall be described in detail below.

In some embodiments, system 100 may further comprise multiple sensing assemblies disposed at one or more respective predefined locations adjacent to blanket 210. The sensing assemblies are configured to produce, in response to sensing the markers, electrical signals, such as position signals indicative of respective positions of the markers. In the context of the present invention and in die claims, the term “signals” may refer to various types of electrical signals, such as position signals, sensed by the sensing assemblies. Various implementations and uses of the markers and of the sensing assemblies are described in further detail, for example, in PCT International Publication WO 2020/003088, whose disclosure is incorporated herein by reference.

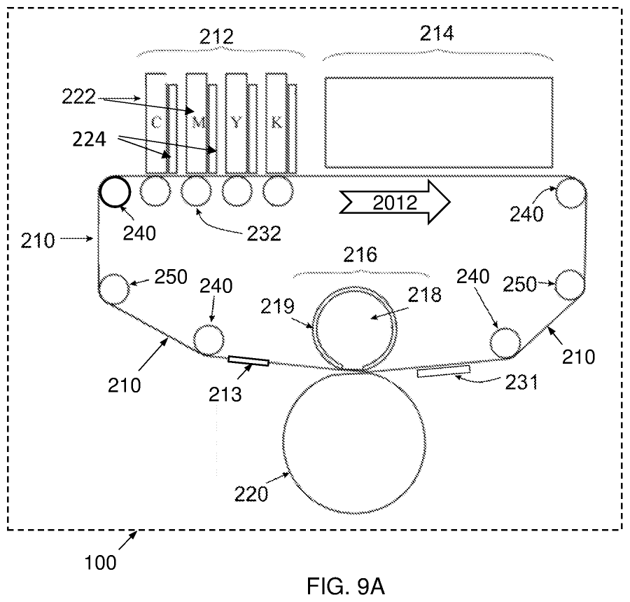

### Discussion of FIG. 10—System Description

FIG. 10 is a schematic side view of a digital printing system, in accordance with an embodiment of the present invention. FIG. 10 is a schematic side view of a digital printing system 10, in accordance with an embodiment of the present invention. In some embodiments, system 10 comprises a rolling flexible ITM 210 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of ITM 210. Subsequently the ink image is transferred to a target substrate, (e.g., a paper, a folding carton, a multilayered polymer, or any suitable flexible package in a form of sheets or continuous web) located under a lower run of ITM 210.

In the context of the present invention, the term “run” refers to a length or segment of ITM 210 between any two given rollers over which ITM 210 is guided.

In some embodiments, during installation, ITM 210 may be adhered edge to edge, using a seam section also referred to herein as a seam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of ITM 210. In some embodiments, each print bar 62 comprises a strip of print heads as wide as the printing area on ITM 210 and comprises individually controllable printing nozzles configured to jet ink and other sort of printing fluids to ITM 210 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black and white. In the example of FIG. 10, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of ITM 210 so as to form the ink image (not shown) on the surface of ITM 210. In the present example, ITM 210 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of ITM 210 or (ii) a printing direction. In the present example, the moving direction of ITM 210 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving ITM 210 are essential for enabling correct placement of the image pattern. In the context of the present disclosure and in the claims, the terms “inter-color pattern placement,” “pattern placement accuracy,” “color-to-color registration,” “C2C registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of ITM 210. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on ITM 210 from undesirably merging into one another.

In some embodiments, system 10 comprises drying station 64, configured to direct infrared radiation and cooling air (or another gas), and/or to blow hot air (or another gas) onto the surface of ITM 210. In some embodiments, drying station 64 may comprise infrared-based illumination assemblies (not shown) and/or air blowers 68 or any other suitable drying apparatus.

In some embodiments, in drying station 64, the ink image formed on ITM 210 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as ITM 210. In some embodiments, blanket module 70 comprises one or more rollers 78, wherein at least one of rollers 78 comprises a motion encoder (not shown), which is configured to record the position of ITM 210, so as to control the position of a section of ITM 210 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, ITM 210 may comprise an integrated encoder (not shown) for controlling the operation of various modules of system 10. One implementation of the integrated motion encoder is described in detail, for example, in PCT International Publications WO 2021/044303, and WO 2020/003088, whose disclosures are all incorporated herein by reference.

In some embodiments, ITM 210 is guided in blanket module 70 over rollers 76, 78 and other rollers described herein, and over a powered tensioning roller, also referred to herein as a dancer assembly 74. Dancer assembly 74 is configured to control the length of slack in ITM 210 and its movement is schematically represented in FIG. 10 by a double-sided arrow. Furthermore, any stretching of ITM 210 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along ITM 210. The tension sensors may be integrated in ITM 210 or may comprise sensors external to ITM 210 using any other suitable technique to acquire signals indicative of the mechanical tension applied to ITM 210. In some embodiments, processor 20 and additional controllers of system 10 are configured to receive the signals produced by the tension sensors, so as to monitor the tension applied to ITM 210 and to control the operation of dancer assembly 74.

In impression station 84, ITM 210 passes between an impression cylinder 82 and a pressure cylinder 90, which is configured to carry a compressible blanket (shown in FIG. 3 below). In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of ITM 210, and/or cleaning the outer surface of ITM 210. At blanket treatment station 52, the temperature of ITM 210 can be reduced to a desired temperature-level before ITM 210 enters into image forming station 60. The treatment may be carried out by passing ITM 210 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may, additionally or alternatively, be applied to ITM 210 by jetting.

In some embodiments, processor 20 is configured to receive, e.g., from temperature sensors (not shown), signals indicative of the surface temperature of ITM 210, so as to monitor the temperature of ITM 210 and to control the operation of blanket treatment station 52. Examples of such treatment stations are described, for example, in PCT International Publications WO 2013/132424 and WO 2017/208152, whose disclosures are all incorporated herein by reference.

In the example of FIG. 10, station 52 is mounted between impression station 84 and image forming station 60, yet, station 52 may be mounted adjacent to ITM 210 at any other or additional one or more suitable locations between impression station 84 and image forming station 60. As described above, station 52 may, additionally or alternatively, be mounted on a bar adjacent to image forming station 60.

In the example of FIG. 10, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of ITM 210 selectively interacts at impression station 84 with impression cylinder 82 to impress the image pattern onto the target flexible substrate compressed between ITM 210 and impression cylinder 82 by the action of pressure of pressure cylinder 90. In the case of a simplex printer (i.e., printing on one side of sheet 50) shown in FIG. 10, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single and double sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

In some embodiments, sheets 50 or continuous web substrate (not shown) are carried by module 80 from input stack 86 and pass through the nip (not shown) located between impression cylinder 82 and pressure cylinder 90. Within the nip, the surface of ITM 210 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of ITM 210. Subsequently, sheet 50 is transported to output stack 88.

In the example of FIG. 10, rollers 78 are positioned at the upper run of ITM 210 and are configured to maintain ITM 210 taut when passing adjacent to image forming station 60. Furthermore, it is particularly important to control the speed of ITM 210 below image forming station 60 so as to obtain accurate jetting and deposition of the ink droplets to form an image, by image forming station 60, on the surface of ITM 210.

In some embodiments, impression cylinder 82 is periodically engaged with and disengaged from ITM 210, so as to transfer the ink images from moving ITM 210 to the target substrate passing between ITM 210 and impression cylinder 82. In some embodiments, system 10 is configured to apply torque to ITM 210 using the aforementioned rollers and dancer assemblies, so as to maintain the upper run taut and to substantially isolate the upper run of ITM 210 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 10, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In some embodiments, the processor is further configured to control additional process steps that are carried out during the digital printing process by several stations and modules of system 100. For example, controlling the process of jetting ink droplets by image forming station 212, controlling the operation of drying station 214 so as to dry the ink image by applying to blanket 210 suitable amount of heat at precise timing, controlling the blanket treatment station configured to apply a treatment fluid to blanket 210, controlling the operation of impression cylinder 220 and pressure cylinder 218 so as to enable precise transfer of the ink image from blanket 210 to a respective sheet 226.

The configuration of system 100 is simplified and provided purely by way of example for the sake of clarifying the present invention. The components, modules and stations described in printing system 100 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The ITM according to the disclosed technology may also be used in other types of printing systems, such as systems configured to print on a continuous web, and systems configured to print on both sides of the sheet, also referred to as duplex printing systems. These web printing and duplex printing systems may comprise, additionally or alternatively to the configuration of system 100, various modules and stations, such as multiple impression stations 216 and different configurations of rollers and dancers. Exemplary modules and stations of such web printing and duplex printing systems are described in detail, for example, in PCT International Publication WO2013/132424 and in U.S. Patent Application Publication 2015/0054865, whose disclosures are all incorporated herein by reference.

In other embodiments, image forming station 212 is configured to apply the printing fluid (e.g., ink, toner) by jetting droplets as described above, or using any other suitable indirect printing technique. For example, image forming station 212 may comprise a photo charging station configured to apply an electrostatic charge image representing the image to be printed, and one or more colors of printing fluids that comprise electrically charged particles that attract to the opposing electrical fields applied to the surface of a transfer member (e.g. blanket 210 or a drum). Subsequently, the transfer member is configured to transfer the image to the target substrate as described above.

The particular configurations of system 100 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems that are known in the art, in particular printing systems using an intermediate transfer member, i.e. indirect printing systems which use, for example, a blanket or a drum to transfer the image to be printed, offset printing systems (e.g. using lithography, flexography, and gravure techniques), digital printing systems (i.e. inkjet and electrophotography), or any combination of such systems. In some embodiments, the ITM is configured to perform a process or a combination of processes, such as but not limited to inkjet, electrophotography, lithography, flexography and gravure. In these embodiments, the printing system may comprise any type of an offset printing system (e.g., using lithography, and/or flexography and/or gravure processes), or any type of a digital printing system (e.g., using inkjet and/or electrophotography processes), or any combination thereof.

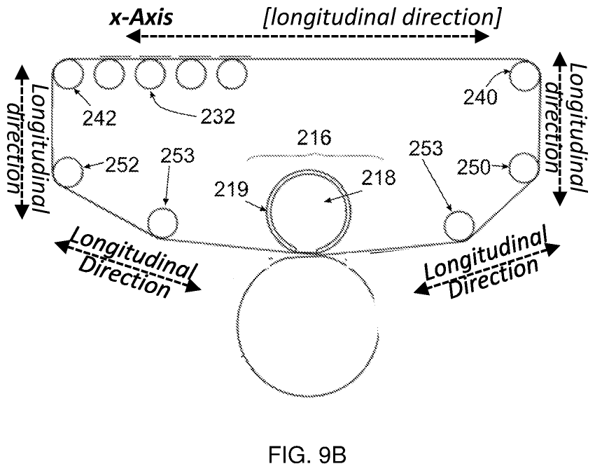

### Discussion of FIGS. 11-13

Reference is now made to FIG. 11, which is a schematic elevation-view illustration of an ITM 210 comprising a paper-based layer 320 and a release layer 310, according to embodiments of the invention. As seen, the release layer 310 is disposed above paper-based layer 320, such that release layer 310 is the upper layer and paper-based layer 320 is the lower layer. The thickness of the ITM, indicated by T_{ITM}, is the combined thickness of release layer 310 and of paper-based layer 320.

In some embodiments, paper-based layer 320 includes less than 50% paper fiber. However, in other embodiments, paper-based layer 320 includes at least 50% paper fiber, at least 60% paper fiber, at least 70% paper fiber, at least 80% paper fiber, or at least 90% paper fiber. In some embodiments, paper-based layer 320 includes 100% paper fiber. In some embodiments, a paper-based layer 320 includes a coated paper, e.g., a paper (or paper-fiber-based layer coated with a resin such as an epoxy resin.

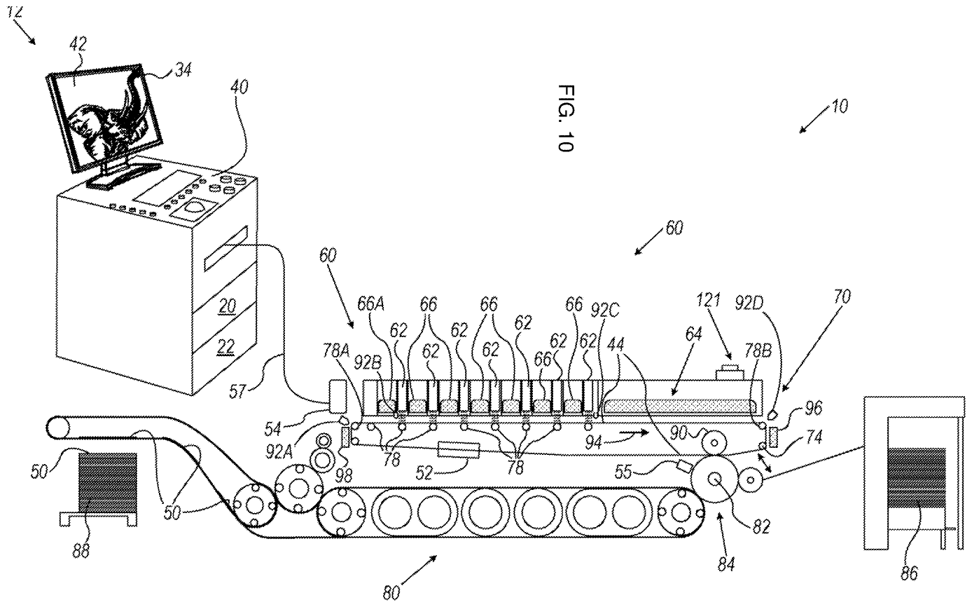

Reference is now additionally made to FIG. 12A, which is a schematic elevation-view illustration of an ITM 210 comprising a glass-fabric layer 330, a paper-based layer 320, and a release layer 310, according to embodiments of the invention, and to FIG. 4B, which shows an exploded view of the ITM 210 of FIG. 12A. Glass-fabric layer 330 may be a woven fabric, having glass fibers woven thereinto. Layers 310 and 320 shown in FIGS. 12A and 12B are equivalent to the layers of the same numbers shown in FIG. 11.

As seen, the release layer 310 is disposed above paper-based layer 320, and the glass-fabric layer 330 is disposed below paper-based layer 320, such that paper-based layer 320 is sandwiched between release layer 310 and glass-fabric layer 330. Release layer 310 includes an upper surface 3101 and a lower surface 3102. Paper-based layer 320 includes an upper surface 3201 and a lower surface 3202. Glass-fabric layer 330 includes an upper surface 3301 and a lower surface 3302.

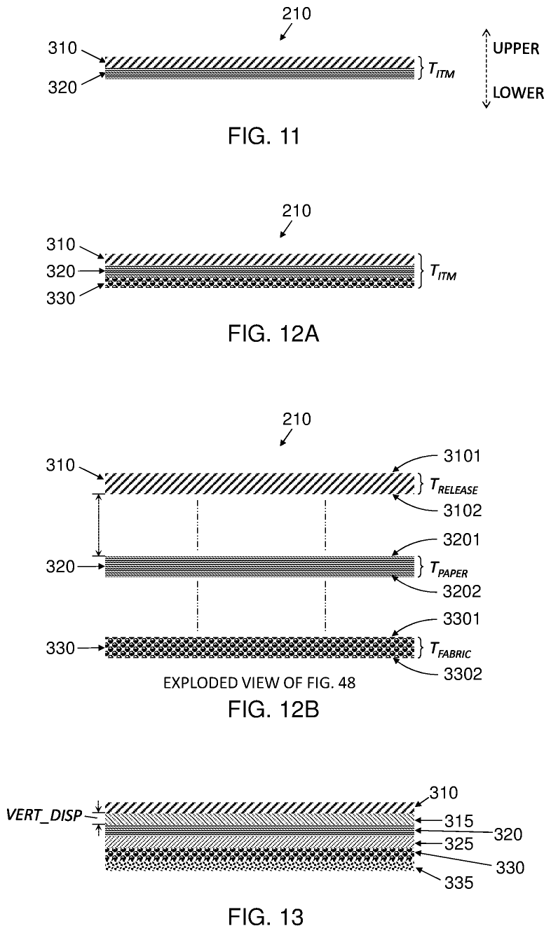

As seen in FIG. 13, the vertical displacement between two layers is defined as the distance between the layers regardless of intervening layers, e.g., VERT_DISP is the vertical displacement between paper-based layer 320 (specifically, its upper surface 3201) and release layer 310 (specifically, its bottom surface 3101).

The thickness of the ITM, indicated by T_{ITM}, is a sum of the thickness of release layer 310 indicated by T_{RELEASE}, the thickness of paper-based layer 320 indicated by T_{PAPER}, and the thickness of glass-fabric layer 330 indicated by T_{FABRIC}.

Glass-fiber fabric layers in ITMs adds enforces the tear-resistant and stretch-resistant characteristics of ITMs; inter alia, these properties help to ensure correct printing and operation of a printing system. However, such fabric-based ITMs have a deficiency of requiring a relatively thick layer of material in order to obtain the desired properties, e.g., minimal surface roughness and low thermal mass.

ITMs formed of a release layer and of a paper-based layer, as disclosed herein, may be thinner than fabric based ITMs, making the system more accurate and easier to maintain. The paper-based layer provides a substantial portion of the stretch-resistance required for the ITM, e.g., as expressed in terms of a spring constant. However, a paper-based layer is typically less tear-resistant than glass-fiber fabric, and the latter provides at least a majority of the tear-resistance of the ITM. A spring constant can be calculated according to Hooke's law by measuring mechanical expansion of the paper layer for a given force.

Reference is now additionally made to FIG. 13, which is a schematic elevation-view illustration of an ITM 210 comprising a glass-fabric layer 330, a paper-based layer 320, a release layer 310, and a plurality of underlying and/or intervening layers 315, 325, and 335, according to embodiments of the invention. Layers 310, 320, and 330 shown in FIG. 13 are equivalent to the layers of the same reference numbers shown in FIGS. 8A and 8B.

In some embodiments, intervening layer 315 disposed between release layer 310 and paper-based layer 320 may be, or may include, a compliance layer or an adhesion and support layer. A compliance layer can be elastomeric layer that allows the release layer 310 and its upper surface 3101 to follow closely the surface contour of a substrate onto which an ink image is impressed. The attachment of the compliance layer to the bottom surface 3102 of the release layer 310 may involve the application of an adhesive or bonding composition in addition to the material of compliance layer 315. Generally, compliance layer 315 may typically have a thickness of between about 100 micrometers and about 300 micrometers or more. While compliance layer 315 may have the same composition as that of release layer 310, material and process economics may warrant the use of less expensive materials. Moreover, compliance layer 315 can be selected to have mechanical properties (e.g., greater resistance to tension) that differ from release layer 310. Such desired differences in properties may be achieved, by way of example, by utilizing a different composition with respect to release layer 310, by varying the proportions between the ingredients used to prepare the formulation of release layer 310, and/or by the addition of further ingredients to such formulation, and/or by the selection of different curing conditions. For instance, the addition of filler particles may favorably increase the mechanical strength of compliance layer 315 relative to release layer 310. In some embodiments, compliance layer 315 may include various rubbers. Preferably such rubbers are stable at temperatures of at least 100° C., and may include rubbers such as alkyl acrylate copolymer rubbers (ACM), methyl vinyl silicone rubber (VMQ), ethylene propylene diene monomer rubber (EPDM), fluoroelastomer polymers, nitrile butadiene rubber (NBR), ethylene acrylic elastomer (EAM), and hydrogenated nitrile butadiene rubber (HNBR).

In some embodiments, intervening layer 325, disposed between paper-based layer 320 and glass-fabric layer 330 may be, or may include, an adhesion and support layer. In some embodiments, underlying layer 335 may be, or may include, a high friction layer, adapted to provide a better grip of the ITM over rollers of the printing system (e.g. rollers 240, 250) during operation of the printing system using the ITM. Various properties of release layer 310, compliance layer 315, support layer 325, glass-fabric layer 330, and high friction layer 335 are described, for example, in U.S. Patent Application Publication No. 2020/0062002, which is incorporated herein by reference as if fully set forth herein.

The following discussion relates to properties of the ITM 210 as shown in FIGS. 7 to 9, where some of the properties, particularly those relating to glass-fabric layer 330, are only applicable to the embodiments of the ITM shown in FIGS. 8A to 9.

In some embodiments, thickness T_{ITM} of ITM 210 is at least 100 μm or at least 200 μm, or at least 250 μm, or at least 300 μm. In some embodiments, thickness T_{ITM} of ITM 210 is at most 600 μm, or at most 500 μm, or at most 400 μm. In some embodiments, ITM 210 has a total length of at least 7m, or at least 8m, or at least 9m, or at least 10m.

In some embodiments, release layer 310 is a silicone-based layer. In some embodiments, release layer 310 is hydrophobic.

In some embodiments, upper surface 3101 of release layer 310 coincides with an upper surface of ITM 210.

In some embodiments, thickness T_{RELEASE} of release layer 310 is least 50 μm, or at least 100 μm. In some embodiments, thickness T_{RELEASE} of release layer 310 is at most 250 μm, or at most 200 μm, or at most 150 μm.

In some embodiments, a ratio between T_{RELEASE} of release layer 310 and thickness T_{ITM} of ITM 210 is at most 0.6, or at most 0.5, or at most 0.4, or at most 0.3. In some embodiments, a ratio between T_{RELEASE} of release layer 310 and thickness T_{ITM} of ITM 210 is at least 0.2, or at least 0.3.

In some embodiments, thickness T_{PAPER} of paper-based layer 320 is at least 25 μm, or at least 50 μm. In some embodiments, thickness T_{PAPER} of the paper-based layer 320 is at most 150 μm, or at most 125 μm, or at most 100 μm, or at most 75 μm.

In some embodiments, a ratio between thickness T_{PAPER} of paper-based layer 320 and thickness T_{ITM} of ITM 210 is at least 0.1, or at least 0.125, or at least 0.15, or at least 0.175, or at least 0.2, or at least 0.225, or at least 0.25, or at least 0.275, or at least 0.3, or at least 0.35, or at least 0.4, or at least 0.45, or at least 0.5.

In some embodiments, a ratio between a spring constant of paper-based layer 310 and a spring constant of ITM 210 is at least 0.3.

In some embodiments, ITM 210 is in the form of an elongated belt defining an elongate longitudinal direction and a traverse direction perpendicular thereto, and a ratio between (i) a longitudinal-direction tensile-strength of paper-based layer 320, and (ii) a longitudinal-direction tensile-strength of ITM 210, is at least 0.1, or at least 0.2, or at least 0.3, or at least 0.4, or at least 0.5, or at least 0.6, or at least 0.7, or at least 0.8, or at least 0.85, or at least 0.9.

In some embodiments, a ratio between thickness T_{RELEASE} of release layer 310 and thickness T_{PAPER} of paper-based layer 320 is at least 0.5. In some embodiments, a ratio between thickness T_{RELEASE} of release layer 310 and thickness T_{PAPER} of paper-based layer 320 is at most 6, or at most 5, or at most 4, or at most 3, or at most 2.5, or at most 2, or at most 1.75.

In some embodiments, a ratio between (i) a vertical displacement between lower surface 3102 of release layer 310 and upper layer 3201 of paper-based layer 320, and (ii) thickness T_{ITM} of ITM 210, is at most 0.2, or at most 0.15, or at most 0.1, or at most 0.05.

In some embodiments, thickness T_{FABRIC} of glass-fabric layer 330 is at most 100 μm, or at most 75 μm, or at most 50 μm.

In some embodiments, paper-based layer 320 is thicker than glass-fabric layer 330. Stated differently, T_{PAPER}>=T_{FABRIC}. In some embodiments, a ratio between thickness T_{FABRIC} of glass-fabric layer 330 and thickness T_{PAPER} of paper-based layer 320 is at most 0.5.

In some embodiments, a ratio between thickness T_{FABRIC} of glass-fabric layer 330 and thickness T_{ITM} of ITM 210 is at most 0.2, or at most 0.15, or at most 0.1.

In some embodiments, the ratio between the tear resistance of glass-fabric layer 330 and the tear resistance of ITM 210 is at least 0.8, and the ratio between the spring constant of paper-based layer 320 and the spring constant of ITM 210 is at least 0.3, at 100° C.

In some embodiments, the ratio between the tear resistance of glass-fabric layer 330 and the tear resistance of ITM 210 is at least 0.9. In some embodiments, a ratio between the tear resistance of glass-fabric layer 330 and the tear resistance of ITM 210 is at least 0.8.

Unless otherwise specified, a tear resistance (or tear resistance ratio) disclosed herein refers to an edge tearing resistance, which refers to the work required to tear a paper sample by starting the tear at the edges of the sheet, as opposed to an internal tearing resistance that refers to resistance to propagation of an existing tear. Tear resistance of paper can be measured by testing the paper-based layer using a paper-industry standard such as the TAPPI T 470 test.

In some embodiments, an average surface roughness of upper surface 3301 of glass-fabric layer 330 in ITM 210 is at most 10 μm, or at most 5 μm, or at most 3 μm, or at most 2 μm, or at most 1 μm. In some embodiments, an average surface roughness of lower surface 3202 of paper-based layer 310 in ITM 210 is at most 10 μm, or at most 5 μm, or at most 3 μm, or at most 2 μm, or at most 1 μm. In some embodiments, an average surface roughness of upper surface 3201 of paper-based layer 320 in ITM 210 is at most 1 μm, or at most 0.5 μm, or at most 0.25 μm, or at most 0.2 μm. In some embodiments, an average surface roughness of upper surface 3101 of release layer 310 is at most 1 μm, or at most 0.5 μm, or at most 0.25 μm, or at most 0.2 μm. Surface roughness is a component of surface texture, quantified by the deviations in the direction of the normal vector of a real surface, i.e., a surface of a layer or an outer surface of the ITM, from its ideal form. If these deviations are large, the surface is rough; if they are small, the surface is smooth. The inventors believe that the relative flatness or smoothness of the smoothness of the release layer on the surface of the ITM affects ink film construction in that an ink film surface can substantially complement that of a surface layer. In other words, it can be desirable to minimize surface roughness because the developing ink film image may substantially retain or completely retain the topography of the upper surface 3101 of release layer 310 through the transfer onto a printing substrate.

In some embodiments, lateral edges of ITM 210 are provided with spaced projections or formations (not explicitly shown) which are adapted to be received in a guide channel in the printing system in order to maintain the ITM taut in its widthways dimension. The formations may be the teeth of one half of a zip fastener that is sewn or otherwise secured to the lateral edge of the belt. As an alternative to spaced formations, a continuous flexible bead of greater thickness than the ITM may be provided along each lateral side. The formations need not be the same on both lateral edges of the belt. They can differ in shape, spacing, composition and physical properties. For example, the formation on one side may provide the elasticity desired to maintain the belt taut when the lateral formations are guided through their respective lateral channels.

The formations may be made of any material able to sustain the operating conditions of the printing system, including the rapid motion of the belt. Suitable materials can resist elevated temperatures in the range of about 50° C. to 250° C. Advantageously, such materials are also friction resistant and do not yield debris of size and/or amount that would negatively affect the movement of the belt during its operative lifespan. For example, the lateral formations can be made of polyamide reinforced with molybdenum disulfide. Further details of non-limiting examples of formations suitable for belts that may be used in the printing systems of the present invention are disclosed in WO 2013/136220, in US 2015/0165759, and in US 2016/0167363, all of which are incorporated by reference as if fully set forth herein.

Reference is now made to FIG. 10, which shows a flowchart of method steps for printing according to embodiments of the invention. As seen in FIG. 6, the method includes an initial step S01 in which an ITM 210 as described herein with respect to any one of FIGS. 7 to 9 is provided. The ITM includes at least release layer 310 having upper surface 3101 for ink reception, and paper-based layer 320 disposed beneath the release layer. The ITM may further include any one or more of the properties of ITM 210 discussed hereinabove with respect to FIGS. 7 to 9.

At step S02, the ITM 210 is mounted onto rollers of a printing system, such as rollers 240 and 250 of printing system 100 shown in FIG. 6, such that the ITM passes through multiple stations of the printing system, such as stations 212, 214, and 216 of FIG. 2.

At step S03, the ITM is formed into endless loop formation by joining ends 211 of ITM 210 to each other, for example using a seam, as shown in FIG. 5B.

At step S04, the ITM-loop is rotated through the stations of printing system 100. During the rotation, ink images are formed by depositing ink-droplet upon upper surface 3101 of release layer 310 of ITM 210 moving through image-forming station 212 of the printing system 100. The ink images are transported, on ITM 210, to impression station 216 of the printing system, and are transferred to a substrate at the impression station.

In some embodiments, the ink-droplets comprise an aqueous ink.

In some embodiments, during the forming and transferring, respective portions of ITM 210 passing through image-forming station 212 and impression station 216 are at temperatures of at least 100° C. In some embodiments, at least a lengthwise majority of ITM 210 is at a temperature of at least 140° C. during the forming, transporting and transferring. In some embodiments, at least a portion of the ITM is at a temperature of at least 200° C. during at least one of the forming, transporting and transferring.

In some embodiments, the transporting of the ink images from image-forming station 212 to impression station 216 is over a distance of at least 3m, or at least 4m, or at least 5m, or at least 6m.

### More About Embodiments Including Both of (i) Fabric Layer and (ii) a Paper-Based Layer

In one example, a first layer (or stack of layers) is fabric-based (e.g. a glass-fabric) and a second layer (or stack of layers) disposed above the first layer (or stack of layers) but below an uppermost “release layer” is paper-based. The first (or stack layers) (i.e. fabric-based—e.g. at least 50% or at least 70% or at least 90% fabric by weight) is primarily responsible for the longitudinal-direction tear resistance of the ITM “Condition A”, while the second layer (or stack of stack of layers) (i.e. paper-based—e.g. at least 50% or at least 70% or at least 90% paper by weight) is primarily responsible for the longitudinal-direction spring coefficient of the ITM, imbuing the ITM with longitudinal stiffness “Condition B”.

In one specific case related to the example of the previous paragraph “Condition C” is also provided-the upper surface of the first layer (or stack of layers) (i.e. fabric-based) is relatively “rough” characterized by a relatively high surface-roughness, the lower surface of the second layer (or stack of layers) (i.e. paper-based) is relative “rough” characterized by a relatively high surface-roughness, the upper surface of the second layer (or stack of layers) (i.e. paper-based) is relative “smooth” characterized by a relatively low surface-roughness.

Thus, in some embodiments:
(i) Part of Condition C→an upper surface of the first layer (or stack of layers) which is fabric-based has a first surface roughness SR_{UPPER-FABRIC}, where SR is an abbreviation for surface roughness (e.g. SR_{UPPER-FABRIC}≥0.25 μm, SR_{UPPER-FABRIC}≥0.5 μm, or SR_{UPPER-FABRIC}≥1 μm, or SR_{UPPER-FABRIC}≥2 μm, or SR_{UPPER-FABRIC}≥5 μm);
(ii) Part of Condition C→the upper surface of the second layer (or stack of layers) which is paper based has a second surface roughness SR_{UPPER-PAPER} which is much smaller than the first surface roughness SR_{UPPER-FABRIC} (e.g. a ratio between SR_{UPPER-FABRIC} and SR_{UPPER-PAPER} is at most 0.1 or at most 0.01. In this way, the paper-based layer (or stack of layers) serves to “absorb” the surface roughness of the fabric-based layer. For example, a lower surface (i.e. facing down towards the fabric layer) of the paper has a surface roughness of SR_{LOWER-PAPER} (e.g. SR_{LOWER-PAPER}≥0.5 μm, or SR_{LOWER-PAPER}≥1 μm, or SR_{LOWER-PAPER}≥2 μm, or SR_{LOWER-PAPER}≥5 μm), and an upper surface (i.e. facing up towards the release layer) of the paper has a surface roughness of SR_{UPPER-PAPER} (e.g. SR_{UPPER-PAPER}≤0.25 μm or SR_{UPPER-PAPER}≤0.2 μm or SR_{UPPER-PAPER}≤0.15 μm, SR_{UPPER-PAPER}≤0.1 μm, or SR_{UPPER-PAPER}≤0.075 μm, or SR_{UPPER-PAPER}≤0.05 μm). For example, SR_{UPPER-PAPER}/SR_{LOWER-PAPER}≤0.5 or ≤0.25 or ≤0.2 or ≤0.1;
(iii) Simultaneous provisioning of Conditions A and B→all of the following is true: (A) ratio_value≥0.7 (B) a ratio between a tear resistance in the ‘longitudinal direction’ of the paper-based layer and a tear resistance in the ‘longitudinal direction’ ITM is at least ratio_value; (C) a ratio between a tear resistance in the ‘longitudinal direction’ of the paper-based layer and a tear resistance in the ‘longitudinal direction’ ITM is at least ratio_value. In some embodiments, ratio_value≥0.8, or ratio_value≥0.9.

This allows to provide an ITM with both of (i) a “good” tear resistance; and (ii) a “good” stiffness which may be advantageous for print-registration. In addition, a presence of the paper layer (or stack of layers) may obviate or eliminate the need for a compliance layer (or stack of layers), allowing for an ITM that is thinner and/or has a lower thermal mass than might be possible otherwise.

It is noted that the above example is one particular example, and other embodiments including a paper-based layer (or stack of layers) as ‘internal layers’ of the ITM are contemplated.

### Manufacturing Techniques

Additional embodiments related to one or more layers of ITM 210, and manufacturing techniques of at least some of the stacked layers of ITM 210, are described in detail in PCT application PCT/IB2019/055288 and in PCT international publication WO 2017/208144, whose disclosures are incorporated herein by reference.

### Additional-Discussion

There is therefore provided, in accordance with an Inventive Concept 1 of the present invention an intermediate transfer member (ITM) for use in a printing system, the ITM comprising:
a. a release layer having an upper surface for ink-reception; and
b. a paper-based layer disposed beneath the release layer.
Inventive Concept 2. The ITM of Inventive Concept 1, wherein the paper-based layer includes less than 50% paper fiber.
Inventive Concept 3. The ITM of Inventive Concept 1, wherein the paper-based layer includes at least 50%, at least 60%, at least 70%, at least 80%, or at least 90% paper fiber.
Inventive Concept 4. The ITM of Inventive Concept 1, wherein the paper-based layer comprises 100% paper fiber.
Inventive Concept 5. The ITM of any preceding Inventive Concept, wherein the paper-based layer is an interior-layer of the ITM, and one or more additional layers are disposed beneath the paper-based layer.
Inventive Concept 6. The ITM of any preceding Inventive Concept wherein the paper-based layer is an interior layer of the ITM.
Inventive Concept 7. The ITM of Inventive Concept 6 wherein a water-proof barrier exists (e.g. due at least in part to a presence of the release layer) between an upper surface of the ITM and an upper surface of the paper-based layer.
Inventive Concept 8. The ITM of any preceding Inventive Concept wherein the ITM is provided as an elongated strip or as a belt to define longitudinal and lateral directions.
Inventive Concept 9. The ITM of any one of Inventive Concepts 1-8, wherein a ratio between (i) a spring constant in longitudinal direction of the paper-based layer; and (ii) a spring constant in the longitudinal direction of the ITM is at least 0.3 or at least 0.4 or at least 0.6 or at least 0.7 or at least 0.8 or at least 0.9.
Inventive Concept 10. The ITM of any one of Inventive Concepts 9, wherein a ratio between (i) a spring constant in longitudinal direction of the paper-based layer; and (ii) a spring constant in the longitudinal direction of the ITM is at least 0.6.
Inventive Concept 11. The ITM of any one of Inventive Concepts 1-10, wherein a ratio between (i) a tensile strength in longitudinal direction of the paper-based layer; and (ii) a tensile strength in the longitudinal direction of the ITM is at most 0.5 or at most 0.4 or at most 0.3 or at most 0.2 or at most 0.1.
Inventive Concept 12. The ITM of any one of Inventive Concepts 1-10, wherein a ratio between (i) a tensile strength in longitudinal direction of the paper-based layer; and (ii) a tensile strength in the longitudinal direction of the ITM is at least 0.3 or at least 0.4 or at least 0.6 or at least 0.7 or at least 0.8 or at least 0.9.
Inventive Concept 13. The ITM of any preceding Inventive Concept, wherein a thickness of the paper-based layer is at least 25 μm, or at least 50 μm.
Inventive Concept 14. The ITM of any preceding Inventive Concept, wherein a thickness of the paper-based layer is at most 150 μm, or at most 125 μm, or at most 100 μm, or at most 75 μm.
Inventive Concept 15. The ITM of any preceding Inventive Concept, wherein a ratio between a thickness of the paper-based layer and a thickness of the ITM is at least 0.1, or at least 0.125, or at least 0.15, or at least 0.175, or at least 0.2, or at least 0.225, or at least 0.25, or at least 0.275, or at least 0.3, or at least 0.35, or at least 0.4, or at least 0.45, or at least 0.5.
Inventive Concept 16. The ITM of any preceding Inventive Concept, wherein a ratio between a thickness of the paper-based layer and a thickness of the ITM is at least 0.5 or at least 0.55 or at least 0.6 or at least 0.65 or at least 0.7.
Inventive Concept 17. The ITM of any Inventive Concept, wherein the ITM is in the form of an elongated belt defining an elongate longitudinal direction and a traverse direction perpendicular thereto, and a ratio between (i) a longitudinal-direction tensile-strength of the paper-based layer, and (ii) a longitudinal-direction tensile-strength of the ITM, is at least 0.1, or at least 0.2, or at least 0.3, or at least 0.4, or at least 0.5, or at least 0.6, or at least 0.7, or at least 0.8, or at least 0.85, or at least 0.9.
Inventive Concept 18. The ITM of any one of the preceding Inventive Concept, wherein the paper-based layer includes a coated paper.
Inventive Concept 19. The ITM of Inventive Concept 18, wherein the coated paper includes an epoxy resin.
Inventive Concept 20. The ITM of any preceding Inventive Concept, where the paper-based layer lacks one or both of an interior plastic layer or an interior fabric layer.
Inventive Concept 21. The ITM of any preceding Inventive Concept, additionally comprising fabric layer disposed beneath the paper-based layer.
Inventive Concept 22. The ITM of Inventive Concept 21 wherein the fabric layer is a glass-fabric layer.
Inventive Concept 23. The ITM of any preceding Inventive Concept, wherein a ratio between a tear resistance of the fabric layer in the longitudinal direction and a tear resistance of the ITM in the longitudinal direction is at least 0.4 or at least 0.7 or at least 0.8.
Inventive Concept 24. The ITM of any preceding Inventive Concept, wherein a ratio between a spring constant in the normal direction of the paper-based layer and a spring constant in the normal direction of the ITM is at least 0.3 or at least 0.4 or at least 0.6 or at least 0.7 or at least 0.8 or at least 0.9.
Inventive Concept 25. The ITM of any preceding Inventive Concept, wherein an average surface roughness of an upper surface of the fabric layer in the ITM is at least 10 μm, or at least 5 μm, or at least 3 μm, or at least 2 μm, or at least 1 μm.
Inventive Concept 26. The ITM of any preceding Inventive Concept, wherein an average surface roughness of a lower surface of the paper-based layer in the ITM is at most 10 μm, or at most 5 μm, or at most 3 μm, or at most 2 μm, or at most 1 μm.
Inventive Concept 27. The ITM of any preceding Inventive Concept, wherein an average surface roughness of an upper surface of the paper-based layer in the ITM is at most 1 μm, or at most 0.5 μm, or at most 0.25 μm, or at most 0.2 μm.
Inventive Concept 28. The ITM of any preceding Inventive Concept, wherein an average surface roughness of an upper surface of the release layer is at most 1 μm, or at most 0.5 μm, or at most 0.25 μm, or at most 0.2 μm.
Inventive Concept 29. The ITM of any preceding Inventive Concept, wherein the paper-based layer is thicker than the fabric layer.
Inventive Concept 30. The ITM of any preceding Inventive Concept, wherein a thickness of the fabric layer is at most 100 μm, or at most 75 μm, or at most 50 μm.
Inventive Concept 31. The ITM of any preceding Inventive Concept, wherein a ratio between a thickness of the fabric layer and a thickness of the paper-based layer is at most 0.5.
Inventive Concept 32. The ITM of any preceding Inventive Concept, wherein a ratio between a thickness of the fabric layer and a thickness of the ITM is at most 0.2, or at most 0.15, or at most 0.1.
Inventive Concept 33. The ITM of any preceding Inventive Concept, wherein the ratio between the tear resistance of the fabric layer in the longitudinal direction and the tear resistance of the ITM in the longitudinal direction is at least 0.8, and the ratio between the spring constant of the paper-based layer in the longitudinal direction and the spring constant of the ITM in the longitudinal direction is at least 0.3, at 100° C.
Inventive Concept 34. The ITM of any preceding Inventive Concept, wherein the ratio between the tear resistance of the fabric layer in the longitudinal direction and the tear resistance of the ITM in the longitudinal direction is at least 0.9.
Inventive Concept 35. The ITM of any preceding Inventive Concept, wherein the fabric layer comprises at least one of epoxy, starch and silicone.
Inventive Concept 36. The ITM of any preceding Inventive Concept, wherein the release layer is hydrophobic.
Inventive Concept 37. The ITM of any preceding Inventive Concept, wherein the release layer is silicone-based.
Inventive Concept 38. The ITM of Inventive Concept 37 wherein the release layer formed of an addition-cured silicone material.
Inventive Concept 39. The ITM of Inventive Concept 37 wherein an upper surface of the release layer is a release layer having an ink reception surface for receiving an ink image.
Inventive Concept 40. The ITM of Inventive Concept 39 wherein said ink reception surface is adapted to satisfy one or more (i.e. any combination of) of the following structural properties:
   (i) a receding contact angle of a droplet of distilled water on said ink reception surface is at most 60°; and/or
   (ii) for a droplet of distilled water deposited on said ink reception surface, a 10 second dynamic contact angle (DCA) is at most 108°.
Inventive Concept 41. The ITM of Inventive Concept 40 wherein the release layer has at least one of the following structural properties:
   (1) said addition-cured silicone material consisting essentially of an addition-cured silicone, or containing, by weight, at least 95% of said addition-cured silicone;
   (2) functional groups make up at most 10% or at most 7.5% or at most 5% or at most 4% or at most 3%, by weight, of said addition-cured silicone material.
Inventive Concept 42. The ITM of any preceding Inventive Concept, wherein the upper surface of the release layer coincides with an upper surface of the ITM.
Inventive Concept 43. The ITM of any preceding Inventive Concept, wherein a thickness of the release layer is least 50 μm, or at least 100 μm.
Inventive Concept 44. The ITM of any one preceding Inventive Concept, wherein a thickness of the release layer is at most 250 μm, or at most 200 μm, or at most 150 μm.
Inventive Concept 45. The ITM of any preceding Inventive Concept, wherein a ratio between a thickness of the release layer and a thickness of the ITM is at most 0.6, or at most 0.5, or at most 0.4, or at most 0.3.
Inventive Concept 46. The ITM of any preceding Inventive Concept, wherein a ratio between a thickness of the release layer and a thickness of the ITM is at least 0.2, or at least 0.3.
Inventive Concept 47. The ITM of any preceding Inventive Concept, wherein a ratio between a thickness of the release layer and a thickness of the paper-based layer is at least 0.5.
Inventive Concept 48. The ITM of any preceding Inventive Concept, wherein a ratio between a thickness of the release layer and a thickness of the paper-based layer is at most 6, or at most 5, or at most 4, or at most 3, or at most 2.5, or at most 2, or at most 1.75.
Inventive Concept 49. The ITM of any preceding Inventive Concept, wherein the release layer has a lower surface facing towards the paper-based layer, and a ratio between (i) a vertical displacement between the lower surface of the release layer and the paper-based layer, and (ii) a thickness of the ITM, is at most 0.2, or at most 0.15, or at most 0.1, or at most 0.05.
Inventive Concept 50. The ITM of any preceding Inventive Concept, having a total length of at least 7m, or at least 8m, or at least 9m, or at least 10m.
Inventive Concept 51. The ITM of any preceding Inventive Concepts, wherein a thickness of the ITM is at least 100 μm or at least 200 μm, or at least 250 μm, or at least 300 μm.
Inventive Concept 52. The ITM of any preceding Inventive Concept, wherein a thickness of the ITM is at most 600 μm, or at most 500 μm, or at most 400 μm.
Inventive Concept 53. The ITM of any preceding Inventive Concepts wherein a ratio between a surface roughness of the ITM upper surface and a surface roughness of an upper surface a glass fiberglass-based layer is at most 0.2 or at most 0.1 or at most 0.05.
Inventive Concept 54. The ITM of any preceding Inventive Concept wherein a surface roughness of an upper surface of the ITM is at most 0.5 μm or at most 0.25 um or at most 0.15 μm or at most 0.1 μm.
Inventive Concept 55. The ITM of any preceding Inventive Concepts wherein a surface roughness of an upper surface of the ITM is at at most 0.5 μm or at most 0.25 μm or at most 0.15 μm or at most 0.1 μm after the upper surface of ITM is subjected to at least N 2+-second heating(120+° C.)/4+-second cooling (90−° C.) events, wherein N is a positive integer whose value is at least 2.
Inventive Concept 56. The ITM of Inventive Concept 75 wherein a value of N is at least 10 or at least 100 or at least 1000 or at least 5000 or at least 10,000 or at least 50,000 or at least 100,000.
Inventive Concept 57. The ITM of any preceding Inventive Concept wherein a surface roughness of an upper surface of the ITM is at at most 0.5 μm or at most 0.25 μm or at most 0.15 μm or at most 0.1 μm after the upper surface of ITM is subjected to at least N 1+-second heating(120+° C.)/2+-second cooling (90−° C.) events, wherein N is a positive integer whose value is at least 2.
Inventive Concept 58. The ITM of Inventive Concept 57 wherein a value of Nis at least 10 or at least 100 or at least 1000 or at least 5000 or at least 10,000 or at least 50,000 or at least 100,000.
Inventive Concept 59. The ITM of any preceding Inventive Concepts wherein the ITM is characterized by an absence of any interior layer of the ITM whose direction-maximized CLTE value is at least 10*10⁻⁶ meter/(meter ° C.) or at least 15*10⁻⁶ meter/(meter ° C.) at least 20*10⁻⁶ meter/(meter ° C.)
Inventive Concept 60. The ITM of any preceding Inventive Concept wherein the support layer further comprises a fabric layer disposed below the paper layer.
Inventive Concept 61. The ITM of any preceding Inventive Concept wherein a thickness of the fabric layer is at most 100 microns or at most 75 microns or at most 50 microns.
Inventive Concept 62. The ITM of any one of Inventive Concepts 60-61 wherein a ratio between a thickness of the fabric layer and a thickness of the paper layer is at most 0.5.
Inventive Concept 63. The ITM of any one of Inventive Concepts 60-61 wherein a ratio between a thickness of the fabric layer and a thickness of the ITM is at most 0.2 or at most 0.15 or at most 0.1.
Inventive Concept 64. The ITM of any one of Inventive Concepts 60-63, wherein the ITM is in the form of an elongated belt defining an elongate longitudinal direction and a traverse direction co-planar with and perpendicular thereto, and a ratio between: (i) a longitudinal-direction tensile-strength of the fabric layer; and (ii) a longitudinal-direction tensile-strength of the paper layer, is at least 0.5 and/or at most 2.
Inventive Concept 65. The ITM of any one of Inventive Concepts 60-64 wherein an average roughness of the upper surface of the fabric layer is between 3 microns and 50 microns.
Inventive Concept 66. The ITM of any preceding Inventive Concept, wherein at least lateral edge is provided with a plurality of formations that are spaced from one another along the length of the strip.
Inventive Concept 67. The ITM of Inventive Concept 66, wherein the spaced formations are teeth of one half of a zip fastener that is secured to the belt along the side of the strip.
Inventive Concept 68. The ITM of either one of Inventive Concept 66 or 67, wherein the formations comprise two flexible beads of greater thickness than the strip, arranged one on each side of the ITM.
Inventive Concept 69. The ITM of any preceding Inventive Concept, wherein the ITM is formed by a flat elongate strip of which the ends are secured to one another at a seam to form a continuous loop.
Inventive Concept 70. The ITM of Inventive Concept 69 wherein the ends are secured to each other by a heat-curable tape.
Inventive Concept 71. The ITM of any preceding Inventive Concept wherein a bottom-most layer of the ITM is electrically conductive and/or comprises a silicone and/or a rubber and/or a silicone rubber.
Inventive Concept 72. The ITM of any previous Inventive Concept wherein the paper is black and/or has a black upper surface.
Inventive Concept 73. The ITM of any previous Inventive Concept further comprising an additional electromagnetic-energy-absorbing layer above the paper layer and below the release layer, said energy-absorbing layer comprising black material.
Inventive Concept 74. The ITM of Inventive Concept 73 wherein the black material comprises carbon black.
Inventive Concept 75. The ITM of Inventive Concept 73 wherein energy-absorbing layer is a layer of carbon-black-impregnated silicone.
Inventive Concept 76. A method of printing using a printing system, comprising:
   a. providing an ITM according to any one of the preceding Inventive Concepts;
   b. mounting the ITM on rollers of the printing system so that the ITM passes through multiple stations of the printing system;
   c. forming an endless ITM-loop by joining two ends of the ITM to each other;
   d. forming ink images by ink-droplet deposition upon a surface of the ITM moving through an image-forming station of the printing system;
   e. transporting the ink images on the ITM to an impression station of the printing system; and
   f. transferring the ink images to a substrate at an impression station of the printing system.
Inventive Concept 77. The method of claim 76, wherein the ink-droplets comprise an aqueous ink.
Inventive Concept 78. The method of either one of Inventive Concepts 76 or 77, wherein during the forming and transferring, respective portions of the ITM passing through the image-forming station and the impression station are at temperatures of at least 100° C.
Inventive Concept 79. The method of any one of Inventive Concepts 76 to 78, wherein at least a lengthwise majority of the ITM is at a temperature of at least 140° C. during the forming, transporting and transferring.
Inventive Concept 80. The method of any one of Inventive Concepts 76 to 79, wherein at least a portion of the ITM is at a temperature of at least 200° C. during at least one of the forming, transporting and transferring.
Inventive Concept 81. The method of any one of Inventive Concepts 76 to 80, wherein the transporting of the ink images from the image-forming station to the impression station is over a distance of at least 3 m, or at least 4 m, or at least 5 m, or at least 6 m.
Inventive Concept 82. A method of printing, comprising:
   a. providing an intermediate transfer (ITM) of any one of the preceding Inventive Concepts;
   b. mounting the ITM on rollers of a printing system so that the ITM passes through multiple stations of the printing system;
   c. forming an endless ITM-loop by joining two ends of the ITM to each other; and
   d. rotating the ITM-loop through the multiple stations so that respective portions of the ITM successively pass (i) an image-forming station where ink images are formed by deposition of droplets of an aqueous ink upon an ITM-portion-surface and (ii) an impression station where the ink images are transferred from the ITM to a substrate.

### Concluding Remarks

As used herein in the specification and in the claims section that follows, the term “receding contact angle” or “RCA”, refers to a receding contact angle as measured using a Dataphysics OCA15 Pro Contact Angle measuring device, or a comparable Video-Based Optical Contact Angle Measuring System, using the above-described Drop Shape Method, at ambient temperatures. The analogous “advancing contact angle”, or “ACA”, refers to an advancing contact angle measured substantially in the same fashion.

As used herein in the specification and in the claims section that follows, the term “dynamic contact angle” or “DCA”, refers to a dynamic contact angle as measured using a Dataphysics OCA15 Pro Contact Angle measuring device, or a comparable Video-Based Optical Contact Angle Measuring System, using the method elaborated by Dr. Roger P. Woodward in the above-referenced “Contact Angle Measurements Using the Drop Shape Method”, at ambient temperatures, and as elaborated hereinabove in Example 17.

As used herein in the specification and in the claims section that follows, the term “standard aging procedure” refers to an accelerated aging protocol performed on each tested release layer at 160° C., for 2 hours, in a standard convection oven.

As used herein in the specification and in the claims section that follows, the term “standard air curing” refers to a conventional curing process for curing the release layer, described with respect to Comparative Examples 1A-1F, in which, during the curing of the release layer, the release layer surface (or “ink reception surface”) is exposed to air.

As used herein in the specification and in the claims section that follows, the term “bulk hydrophobicity” is characterized by a receding contact angle of a droplet of distilled water disposed on an inner surface of the release layer, the inner surface formed by exposing an area of the cured silicone material within the release layer.

As used herein in the specification and in the claims section that follows, the terms “hydrophobicity” and “hydrophilicity” and the like, may be used in a relative sense, and not necessarily in an absolute sense.

As used herein in the specification and in the claims section that follows, the term “functional group” refers to a group or moiety attached to the polymer structure of the release layer, and having a higher polarity than the O—Si—O group of conventional addition-cured silicones. Various examples are provided herein. The inventors observe that pure addition cure polydimethyl siloxane polymer contains O—Si—O, SiO₄, Si—CH₃ and C—C groups, and that most other functional groups will have a higher dipole, such that they may be considered “functional”. It will be appreciated by those of skill in the art that such functional groups, may have a tendency or strong tendency to react with components typically present in aqueous inks utilized in indirect inkjet printing, at process temperatures of up to 120° C.

As used herein in the specification and in the claims section that follows, the term “%” refers to percent by weight, unless specifically indicated otherwise.

Similarly, the term “ratio”, as used herein in the specification and in the claims section that follows, refers to a weight ratio, unless specifically indicated otherwise.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the present invention has been described with respect to various specific embodiments presented thereof for the sake of illustration only, such specifically disclosed embodiments should not be considered limiting. Many other alternatives, modifications and variations of such embodiments will occur to those skilled in the art based upon Applicant's disclosure herein. Accordingly, it is intended to embrace all such alternatives, modifications and variations and to be bound only by the spirit and scope of the invention as defined in the appended claims and any deviations falling within their range of equivalency.

To the extent necessary to understand or complete the disclosure of the present invention, all publications, patents, and patent applications mentioned in this specification, including WO 2013/132418, are expressly incorporated in their entirety by reference into the specification, to the same extent as if each individual publication, patent or patent application was specifically and individually indicated to be incorporated herein by reference.

Citation or identification of any reference in this application shall not be construed as an admission that such reference is available as prior art to the invention.

Certain marks referenced herein may be common law or registered trademarks of third parties. Use of these marks is by way of example and shall not be construed as descriptive or limit the scope of this invention to material associated only with such marks.

What is claimed is

1. An intermediate transfer member (ITM) for use in a printing system, the ITM comprising:
a. a silicone-based release layer having an upper surface for ink-reception, said upper-surface for ink-reception adapted to satisfy at least one of a first structural property and a second structural property, the first and second structural properties being defined below;
b. a paper-based layer which is impregnated with and/or coated with epoxy, said paper-based layer being disposed beneath the release layer including at least 50% or at least 60% or at least 80% paper fiber, the paper-based layer configured to contribute to ITM stiffness such that a ratio between (i) a spring constant in the longitudinal direction of the paper-based layer; and a (ii) a spring constant in the longitudinal direction of the ITM is at least 0.5 or at least 0.6 or at least 0.7 or at least 0.8;
c. a grip-layer disposed beneath the paper-based layer, wherein:
A. the paper-based layer has a black upper surface and/or the ITM includes comprising an additional electromagnetic-energy-absorbing layer above the paper layer and below the release layer, said energy-absorbing layer comprising black material;
B. according to the first structural property, a receding contact angle of a droplet of distilled water on said upper surface of said silicone-based release layer is at most 60°;
C. according to the second structural property, for a droplet of distilled water deposited on said upper surface of said silicone-based release layer, a 10 second dynamic contact angle (DCA) is at most 108°.

2. The ITM of claim 1 wherein the paper-based layer is impregnated with the epoxy.

3. The ITM of any preceding claim wherein the paper-based layer is coated with the epoxy.

4. The ITM of any preceding claim wherein a ratio between (i) a spring constant in the longitudinal direction of the paper-based layer; and a (ii) a spring constant in the longitudinal direction of the ITM is at least 0.6 or at least 0.7 or at least 0.8.

5. The ITM of any preceding claim wherein a ratio between (i) a longitudinal-direction tensile strength in the longitudinal direction of the paper-based layer; and a (ii) a longitudinal-direction tensile strength in the longitudinal direction of the ITM is at least 0.5 or at least 0.6 or at least 0.7.

6. The ITM of any preceding claim wherein a ratio between (i) a longitudinal-direction tear-resistance in the longitudinal direction of the paper-based layer; and a (ii) a tear-resistance in the longitudinal direction of the ITM is at least 0.5 or at least 0.6 or at least 0.7.

7. The ITM of any preceding claim wherein a presence of the epoxy in or on the paper-based layer contributes at least 20% or at least 30% or at least 40% or at least 50% to the tensile strength of the ITM in the longitudinal direction.

8. The ITM of any preceding claim wherein a presence of the epoxy in or on the paper-based layer contributes at least 20% or at least 30% or at least 40% or at least 50% to the tear resistance of the ITM in the longitudinal direction.

9. The ITM of any preceding claim wherein the grip-layer is electrically conductive.

10. An intermediate transfer member (ITM) for use in a printing system, the ITM comprising:
a. a release layer having an upper surface for ink-reception; and
b. a paper-based layer disposed beneath the release layer and configured to contribute to ITM stiffness such that a ratio between (i) a spring constant in the longitudinal direction of the paper-based layer; and a (ii) a spring constant in the longitudinal direction of the ITM is at least 0.6, said paper-based layer including at least 50% or at least 60% or at least 80% paper fiber;
c. a fabric layer disposed beneath the paper-based layer and configured to contribute to ITM tear resistance such that a ratio between a tear-resistance of the fabric layer in the longitudinal direction and a tear resistance of the ITM in the longitudinal direction is at least 0.6, wherein:
i. an average surface roughness of an upper surface of the fabric layer in the ITM is at least 0.5 μm; and
ii. an average surface roughness of an upper surface of the paper-based layer is at most 0.2 μm.

11. An intermediate transfer member (ITM) for use in a printing system, the ITM comprising:
a. a release layer having an upper surface for ink-reception; and
b. a paper-based layer disposed beneath the release layer and configured to contribute to ITM stiffness such that a ratio between (i) a spring constant in the longitudinal direction of the paper-based layer; and a (ii) a spring constant in the longitudinal direction of the ITM is at least 0.6, said paper-based layer including at least 50% or at least 60% or at least 80% paper fiber;
c. a fabric layer disposed beneath the paper-based layer and configured to contribute to ITM tensile strength such that a ratio between a tensile strength of the fabric layer in the longitudinal direction and a tensile strength of the ITM in the longitudinal direction is at least 0.6, wherein:
i. an average surface roughness of an upper surface of the fabric layer in the ITM is at least 0.5 μm; and
ii. an average surface roughness of an upper surface of the paper-based layer is at most 0.2 μm.

12. The ITM of any one of claims 10-11 wherein the fabric layer is a glass-fabric layer.

13. The ITM of any one of claims 10-12 wherein a ratio between a tear-resistance of the fabric layer in the longitudinal direction and a tear resistance of the ITM in the longitudinal direction is at least 0.8.

14. The ITM of any one of claims 10-13 wherein a ratio between a tensile strength of the fabric layer in the longitudinal direction and a tensile strength of the ITM in the longitudinal direction is at least 0.8.

15. The ITM of any one of claims 10-14 wherein a ratio between (i) a spring constant in the longitudinal direction of the paper-based layer; and a (ii) a spring constant in the longitudinal direction of the ITM is at least 0.8.

16. The ITM of any one of claims 10-15 wherein a ratio between a surface roughness of the ITM upper surface and a surface roughness of an upper surface of the fabric layer is at most 0.1.

17. The ITM of any preceding claim wherein a surface roughness of an upper surface of the ITM is at at most 0.5 μm or at most 0.25 μm or at most 0.15 μm or at most 0.1 μm after the upper surface of ITM is subjected to at least 1000 2+-second heating(120+° C.)/4+-second cooling (90−° C.) events.

18. The ITM of any preceding claim wherein the ITM is characterized by an absence of any interior layer of the ITM whose direction-maximized CLTE value is at least 10*100 meter/(meter ° C.) or at least 15*10⁻⁶ meter/(meter ° C.) at least 20*10⁻⁶ meter/(meter ° C.).

19. The ITM of any preceding claim wherein the ITM lacks one or both of an interior plastic layer.

20. The ITM of any preceding claim, wherein the ITM is formed by a flat elongate strip of which the ends are secured to one another at a seam to form a continuous loop.

21. The ITM of any one of claims 1-9 wherein the electromagnetic-energy-absorbing layer above the paper layer and below the release layer is a layer of carbon-black-impregnated silicone.

22. An intermediate transfer member (ITM) for use in a printing system, the ITM comprising:
a. a silicone-based release layer having an upper surface for ink-reception, said upper-surface for ink-reception adapted to satisfy at least one of a first structural property and a second structural property, the first and second structural properties being defined below;
b. a paper-based layer which is impregnated with and/or coated with silicone, said paper-based layer being disposed beneath the release layer including at least 50% or at least 60% or at least 80% paper fiber, the paper-based layer configured to contribute to ITM stiffness such that a ratio between (i) a spring constant in the longitudinal direction of the paper-based layer; and a (ii) a spring constant in the longitudinal direction of the ITM is at least 0.5 or at least 0.6 or at least 0.7 or at least 0.8;
c. a grip-layer disposed beneath the paper-based layer, wherein:
A. the paper-based layer has a black upper surface and/or the ITM includes comprising an additional electromagnetic-energy-absorbing layer above the paper layer and below the release layer, said energy-absorbing layer comprising black material;
B. according to the first structural property, a receding contact angle of a droplet of distilled water on said upper surface of said silicone-based release layer is at most 60°;
C. according to the second structural property, for a droplet of distilled water deposited on said upper surface of said silicone-based release layer, a 10 second dynamic contact angle (DCA) is at most 108°.

23. A method of manufacturing the ITM of any preceding claim, the method comprising:
a. providing a release-layer-including-structure and a paper-layer-including structure wherein:
i. the release-layer-including structure comprises:
A. a sheet of polyethylene terephthalate (PET); and
B. the release layer of the ITM of any preceding claim disposed on the PET sheet;
ii. the paper-layer-including structure includes the paper-based layer of any preceding claim and optionally an additional optional layer;
b. laminating the paper-layer-including structure to the release-layer-including structure by applying an adhesive therebetween, wherein the method is performed so that an adhesion layer of the adhesive is disposed between the release layer of the ITM of any preceding claim and the paper-layer of the ITM of any preceding claim.

24. The method of manufacturing of claim 23 wherein before the laminating of step (b), the paper-based layer of the release-layer-including structure is coated with and/or impregnated with at least one of epoxy and silicone.

25. The method of manufacturing of any one of claims 23-24 wherein the a sheet of polyethylene terephthalate (PET) of the release-layer-including structure is coated with a fumed metal.

26. A printing system, comprising:
a. an ITM according to any one of claims 1-22, said ITM mounted the ITM on rollers of the printing system;
b. an image-forming station wherein ink images are formed by ink-droplet deposition of an aqueous ink upon a surface of the ITM moving through an image-forming station of the printing system; and
c. an impression-station where the ink images are transferred from the ITM to substrate.

27. A method of printing using a printing system, comprising
a. providing an ITM according to any one of claims 1-22;
b. mounting the ITM on rollers of the printing system so that the ITM passes through multiple stations of the printing system;
c. forming an endless ITM-loop by joining two ends of the ITM to each other;
d. forming ink images by ink-droplet deposition upon a surface of the ITM moving through an image-forming station of the printing system;
e. transporting the ink images on the ITM to an impression station of the printing system; and
f. transferring the ink images to a substrate at an impression station of the printing system.

28. The method of claim 27, wherein the ink-droplets comprise an aqueous ink.

29. The method of either one of claims 27 or 28, wherein during the forming and transferring, respective portions of the ITM passing through the image-forming station and the impression station are at temperatures of at least 100° C.

30. The method of any one of claims 27 to 29, wherein at least a lengthwise majority of the ITM is at a temperature of at least 140° C. during the forming, transporting and transferring.

31. The method of any one of claims 27 to 30, wherein at least a portion of the ITM is at a temperature of at least 200° C. during at least one of the forming, transporting and transferring.

32. The method of any one of claims 27 to 31, wherein the transporting of the ink images from the image-forming station to the impression station is over a distance of at least 3 m, or at least 4 m, or at least 5 m, or at least 6 m.

33. A method of printing, comprising:
a. providing an intermediate transfer (ITM) of any one of the preceding claims;
b. mounting the ITM on rollers of a printing system so that the ITM passes through multiple stations of the printing system;
c. forming an endless ITM-loop by joining two ends of the ITM to each other; and
d. rotating the ITM-loop through the multiple stations so that respective portions of the ITM successively pass (i) an image-forming station where ink images are formed by deposition of droplets of an aqueous ink upon an ITM-portion-surface and (ii) an impression station where the ink images are transferred from the ITM to a substrate.
